(19) United States
(12) Patent Application Publication
(10) Pub. No.: US 2006/0217643 A1
(43) Pub. Date: Sep. 28, 2006

(54) Massaging device

(76) Inventors: Mitsuhisa Yonekawa, Kanagawa (JP); Kouichi Abe, Kanagawa (JP); Hironori Ogawa, Kanagawa (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 10/552,412

(22) PCT Filed: Apr. 9, 2004
(86) PCT No.: PCT/JP04/05121

§ 371 Date: Oct. 7, 2005

(30) Foreign Application Priority Data
Apr. 11, 2003 (JP) 2003-108212

(51) Int. Cl. A61H 9/00

(52) U.S. Cl. 601/148; 601/151; 601/133

(57) ABSTRACT

A massaging apparatus comprises a leg rest 8 including leg supporting members 15 and 16 which are provided with lower thigh-location grooves 15a and 16a for placing user's lower thighs and rotatably provided peripherally of the lower thigh-location grooves 15a and 16a, and airbags 27 and 28 for rotating the leg supporting members 16 and 16 peripherally of the lower thigh-location grooves 15a and 16a. The massaging apparatus also includes airbags 19 to 22 provided in the lower thigh-location grooves 15a and 16a, air supply-exhaust means 35 for operating the airbags 19 to 22 and massaging the lower thighs by the airbags 19 to 22, and an arithmetic control circuit 36 for operating and controlling the airbags 27 and 28 and the air supply-exhaust means 35. The arithmetic control circuit 36 operates the airbags 27 and 28 to rotate the leg supporting members 15 and 16 peripherally of the lower thigh-location grooves 15a and 16a and operates the air supply-exhaust means 35 to massage the lower thighs by the airbags 19 to 22.

### TECHNICAL FIELD

This invention relates to a massaging apparatus in which a massager for massaging a treated part of a user is provided on a treated part-mounting table on which the treated part is disposed.

### BACKGROUND ART

There has been known a conventional chair type-massaging apparatus in which a leg rest provided with lower thigh-location grooves is rotatably provided upwardly and downwardly on a lower portion at a front side of a seat of a chair, the leg rest can be rotated upwardly and downwardly into any angle by a drive means and stopped, airbags are attached on opposite sides in the lower thigh-location grooves, respectively, user's lower thighs inserted in the lower thigh-location grooves are massaged by inflating and deflating the airbags by air supply-exhaust means.

It is known that the leg rest includes a leg placing body which is rotatably attached upwardly and downwardly on the lower portion at the front side of the seat of the chair and leg supporting members which are provided with thigh-location grooves and attached to the leg placing body to be rotatable peripherally of the lower thigh-location grooves (for reference, Japanese Patent Laid-Open 2001-333951, fourth mode, paragraph 0062).

In the leg rest, an inclined angle of the lower thigh-location grooves is adjusted optionally depending on a user's preference by adjusting the leg supporting members peripherally of the lower thigh-location grooves so that massage positions by the airbags for the lower thighs can be changed.

However, in the massaging apparatus having the leg rest, after the inclined angle of the lower thigh-location grooves is adjusted optionally depending on the user's preference, only an operation in which a massage at that angular position is repeated is executed.

In this way, the conventional apparatus is not configured to satisfy because a massage for each of the lower thighs in a peripheral direction thereof is merely partly executed.

An object of the present invention is to provide a massaging apparatus capable of executing a massage of a treated part efficiently by executing a massage for each treated part on the lower thighs in a peripheral direction thereof continuously.

### SUMMARY OF THE INVENTION

To accomplish the above object, a massaging apparatus according to the present invention comprises a treated part-mounting table including a supporting member which is provided with a located groove in which a treated part of a user is disposed and rotatably provided peripherally of the located groove, rotational means for rotating the supporting member peripherally of the located groove, a massager provided in the located groove, massager operating means for operating the massager and massaging the treated part by the massager, and control means for operating and controlling the rotational means and the massager operating means.

The control means is configured to massage the treated part by the massager by operating the massager operating means while operating the supporting member peripherally of the located groove by operating rotational means.

### BRIEF DESCRIPTION OF THE DRAWINGS

FIG. 1 is a perspective view showing a chair including a massaging apparatus according to the present invention.

FIG. 2 is a front view of the chair shown in FIG. 1.

FIG. 3 is a schematic sectional view of a leg rest in FIG. 1.

FIG. 4 is an operational explanatory view of the leg rest in FIG. 3.

FIG. 5 is an enlarged sectional view of a mounting portion of airbags which are rotational means in FIG. 3.

FIG. 6 is a schematic perspective view showing a relationship of a body of the leg rest and leg supporting members in FIG. 3.

FIG. 7 is an exploded perspective view showing a disposition relationship of supporting brackets and airbag supporting members in FIG. 3.

FIG. 8 is an operational explanatory showing a relationship of the chair and the massaging apparatus in FIGS. 1 and 2.

FIG. 9 is an explanatory view showing an operation of the leg rest of the massaging apparatus relative to the chair in FIG. 8.

FIG. 10 is an explanatory view showing an operation of the leg rest of the massaging apparatus relative to the chair in FIG. 8.

FIG. 11 is an explanatory view showing an operation of the leg rest of the massaging apparatus relative to the chair in FIG. 8.

FIG. 12 is a view showing a control circuit for the massaging apparatus in FIGS. 1 to 12.

FIG. 13 is a flow chart showing control operation of the massaging apparatus by an arithmetic control circuit in FIG. 12.

FIG. 14 is a flow chart explaining a basic massage operation in the flow chart shown in FIG. 13.

FIG. 15 is an explanatory view showing a modified example of the massaging apparatus according to the present invention.

FIG. 16 is a front view of a massaging apparatus in a mode 2 for carrying out the present invention

FIG. 17 is an enlarged explanatory view of a remote control shown in FIG. 16.

FIG. 18 is a view of a control circuit of a massaging apparatus in FIG. 16.

FIG. 19 is a flow chart of control of the massaging apparatus by the control circuit in FIG. 18.

FIG. 20 is a flow chart of control of the massaging apparatus by the control circuit in FIG. 18.

### BEST MODE FOR CARRYING OUT THE INVENTION

A mode 1 according to the present invention will be explained with reference to the drawings.

[Structure]

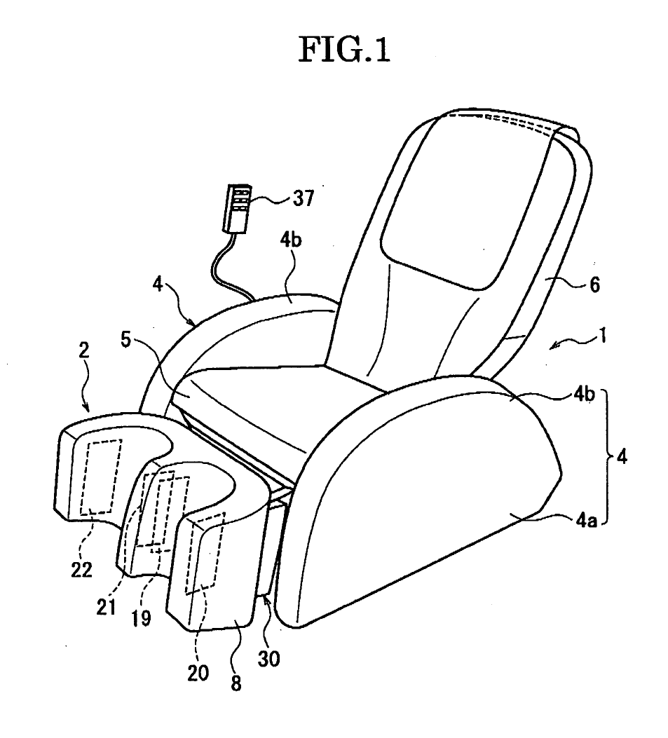

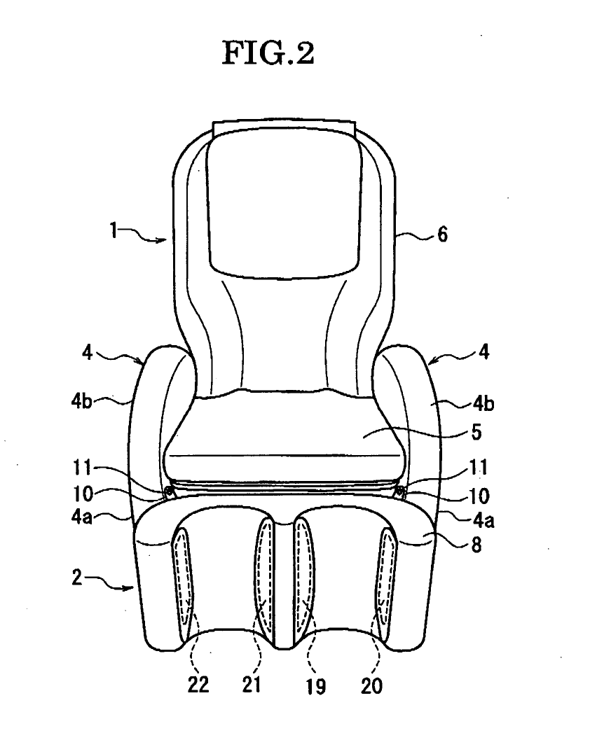

FIGS. 1 and 2 illustrate an example in which a massaging apparatus 2 according to the present invention is provided on a front lower portion of a chair 1. A seat for a vehicle, a chair used in a home, or a chair having a seat or backrest on which a massaging apparatus is provided may be used for the chair 1.

Although the massaging apparatus 2 is described hereinafter as a leg-massaging apparatus for massaging lower thighs which are treated parts, it may be used to massage arms which are the treated parts.

<Chair 1>

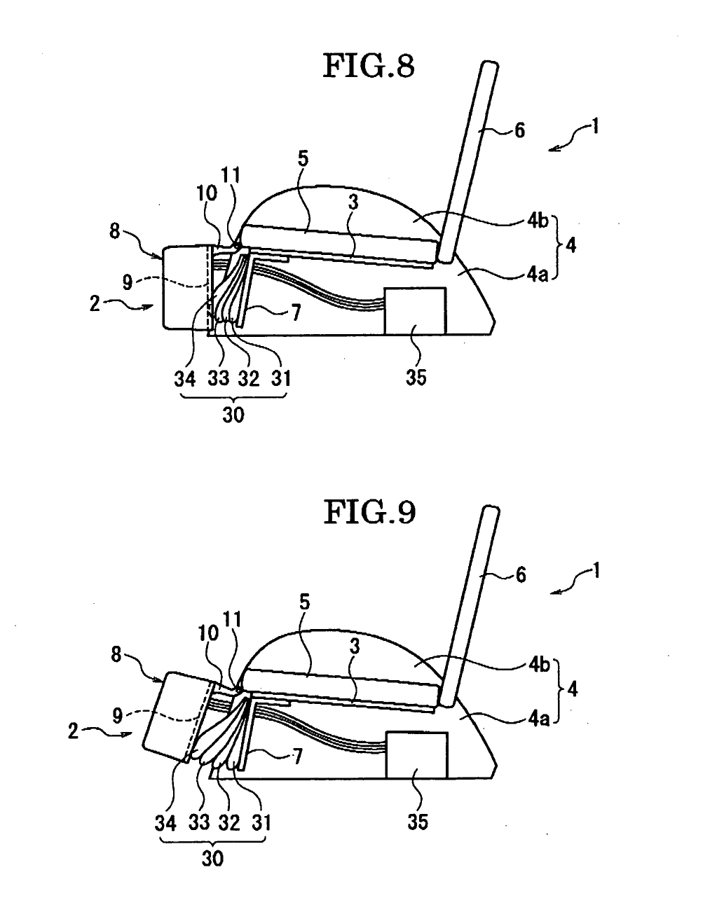

The chair 1 has side supporting members 4 and 4 for arms provided on both side portions of a frame 3 (which is not shown in detail) as shown in FIGS. 8 to 11, a seat 5 disposed on an intermediate portion in an upward-downward direction of the supporting members 4 and 4 and supported on the frame 3, and a backrest 6 disposed on a back portion of the seat 6 and attached to the frame 3. Portions of the side supporting members 4 below the seat 5 are used as leg portions 4a and portions of the side supporting members 4 above the seat 5 are used as elbow rests 4b. Moreover, a downwardly obliquely extending bag supporter 7 is attached to a lower surface of a forward end of the frame 3.

<Massaging Apparatus 2>

(Leg Rest)

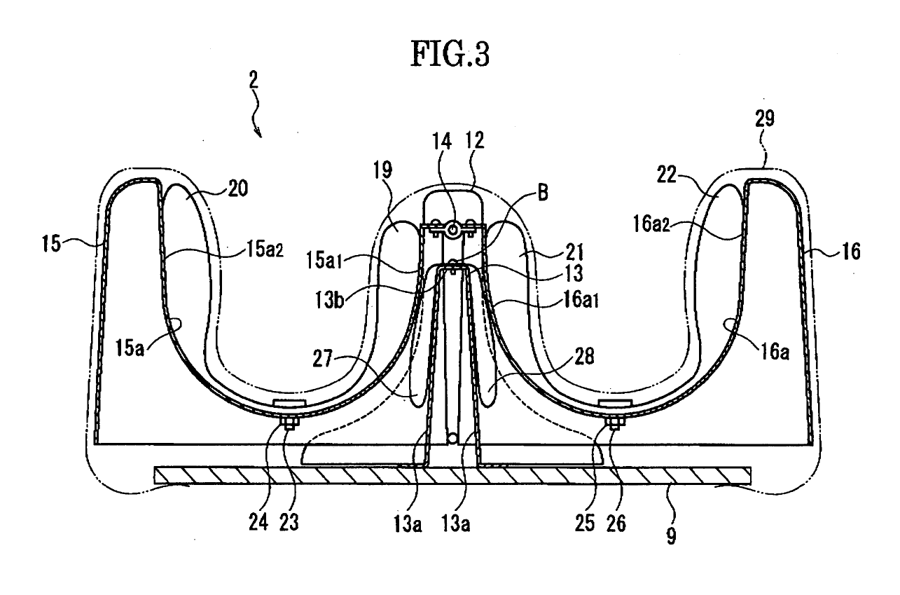

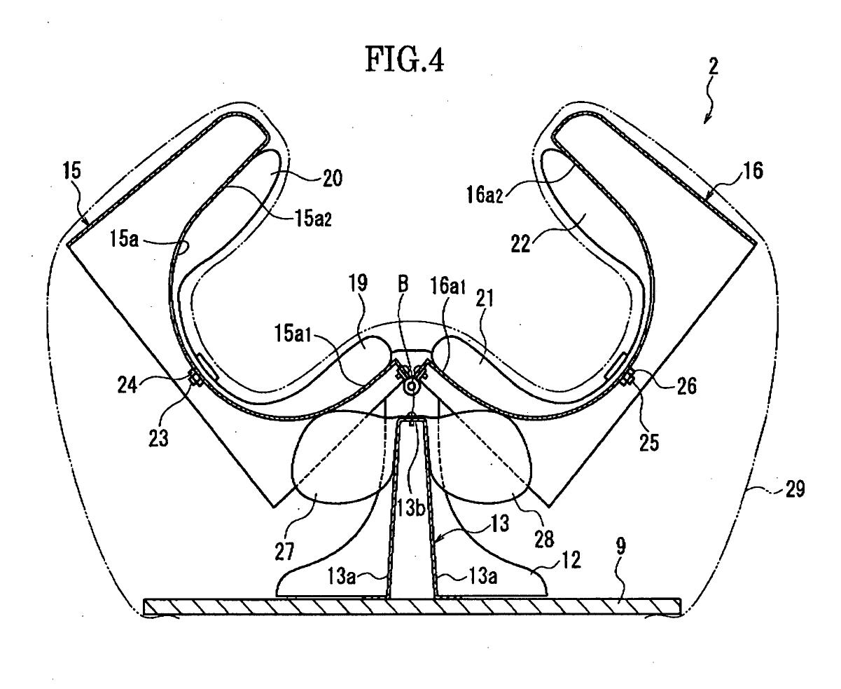

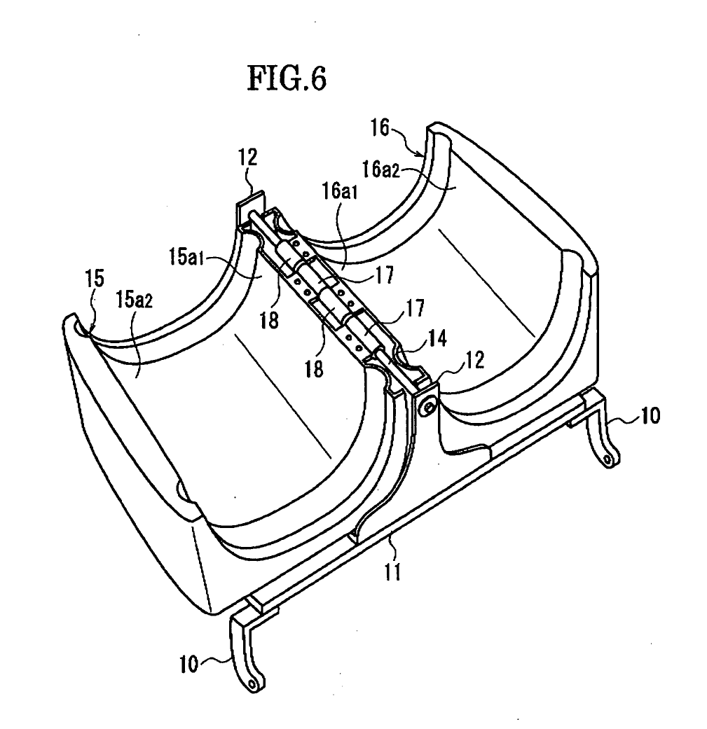

The massaging apparatus 2 includes a leg rest 8 as a table placing a treated part thereon (treated part-mounting table). The leg rest 8 has a plate-like body 9, as shown in FIGS. 3 and 4, and arms 10 (see FIGS. 8 to 11) fixed to right and left both sides of a lower surface of the body 9. Each of the arms 10 projects downwardly as viewed in FIG. 6 (backwardly in FIG. 8), and is disposed below a front end of the seat 5 and rotatably supported on each of the leg portions 4a by a supporting shaft 11 (see FIGS. 2 and 8 to 11).

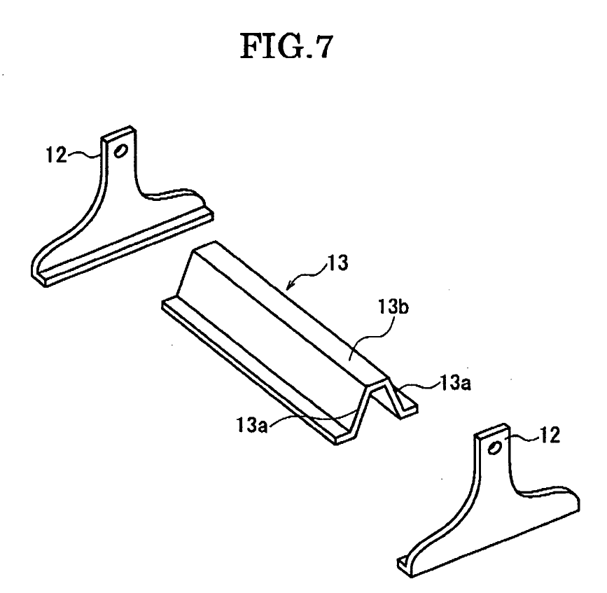

Moreover, the leg rest 8 has a pair of supporting brackets 12 and 12 (see FIG. 7) disposed at a central portion in a right and left direction of the body 9, as shown in FIG. 6 and attached at basic portions thereof to forward and backward edge portions of the body 9, and a bag supporting member 13 disposed between the supporting brackets 12 and 12, as shown in FIG. 7.

The bag supporting member 13 has side walls 13a and 13a fixed at the basic portions to the body 9, as shown in FIGS. 3 and 4 and a top wall 13b connecting leading ends of the side walls 13a and 13b. Meanwhile, the side walls 13a and 13a are inclined to form a reversed V-like shape in which an interval between the side walls 13a and 13a becomes less gradually as going from the base portions to the top wall 13b.

Furthermore, the leg rest 8 has a supporting shaft 14 fixed at both ends thereof to the leading ends of the supporting brackets 12 and 12, leg supporting members 15 and 16 disposed on both sides of the supporting shaft 14, and hinges 17 and 18 configured to rotatably attach the leg supporting members 15 and 16 to the supporting shaft 14. The leg supporting members 15 and 16 have located grooves 15a and 16a to locate the lower thighs, respectively, which extend forwardly and backwardly in FIG. 6 (upwardly and downwardly in FIGS. 1 and 2).

(Means for Carrying Out Treatment)

Moreover, the massaging apparatus 2 includes airbags 19 and 20 as massagers which are disposed along opposing side walls 15a1 and 15a2 of the lower thigh-location groove 15a for placing the treated part and airbags 21 and 22 as massagers which are disposed along opposing side walls 16a1 and 16a2 of the lower thigh-location groove 16a, as shown in FIGS. 3 and 4. Because the airbags 19 to 22 have a certain degree of shape retention, they are retained along the side walls 15a1, 15a2, 16a1 and 16a2 by an elastic force of each airbag itself.

Meanwhile, in the present embodiment, the airbags 19 and 20 are fixed at a connection part thereof to a bottom portion of the lower thigh-location groove 15a by a bolt 23 and a nut 24, and the airbags 21 and 22 are fixed at a connection part thereof to a bottom portion of the lower thigh-location groove 16a by a bolt 25 and a nut 26. The airbags 19 and 20 are formed integrally, but they may be formed separately and the separately formed airbags may be separately attached to the lower thigh-location groove 15a. This also is applied to the airbags 21 and 22, similarly.

(Rotational Means for Swinging the Leg Supporting Members)

Furthermore, the massaging apparatus 2 includes an airbag 27 as a rotational means for swinging the leg supporting member, which is disposed between one of the sides 13a and 13a of the bag supporting member 13 and the side wall 15a1 of the leg supporting member 15, and an airbag 28 as rotational means for swinging the leg supporting member, which is disposed between the other of the sides 13a and 13a of the bag supporting member 13 and the side wall 15a1 of the leg supporting member 15, as shown in FIGS. 3 to 5. The airbags 27 and 28 are attached to the top wall 13b of the bag supporting member 13 by a screw B as fixing means. Meanwhile, the airbags 27 and 28 may be structured by two or more overlapped airbags, respectively. In this case, a rotational amount of the leg supporting members 15 and 16 can be increased.

Moreover, the airbags 27 and 28 are inflated to the maximum by supplying air therein, thus the leg supporting members 15 and 16 can be rotated about the supporting shaft 14 to a position where the lower thigh-location grooves 15a and 16a are disposed to face mutually in inclined states.

(Cover)

The massaging apparatus 2 further has a retractable cover 29 covering the body 9 of the leg rest 8 and the parts mounted on the body S. The cover 9 is disposed along the lower thigh-location grooves 15a and 16a to hold the airbags 19 and 20 along the opposing side walls 15a1 and 16a2 of the lower thigh-location groove 15a and mount the airbags 21 and 22 along the opposing side walls 16a1 and 16a2 of the lower thigh-location groove 16a.

(Lifting and Lowering Swing Means for Leg Rest 8)

Moreover, the massaging apparatus 2 has a lifting and lowering drive means 30 provided between the body 9 of the leg rest and the bag supporter 7 as rest driving means for swinging upwardly and downwardly, as shown in FIGS. 8 to 11. The lifting and lowering drive means 30 comprises a plurality of airbags 31, 32. 33 and 34 which are overlapped on and attached to a forward surface of the bag supporter 7.

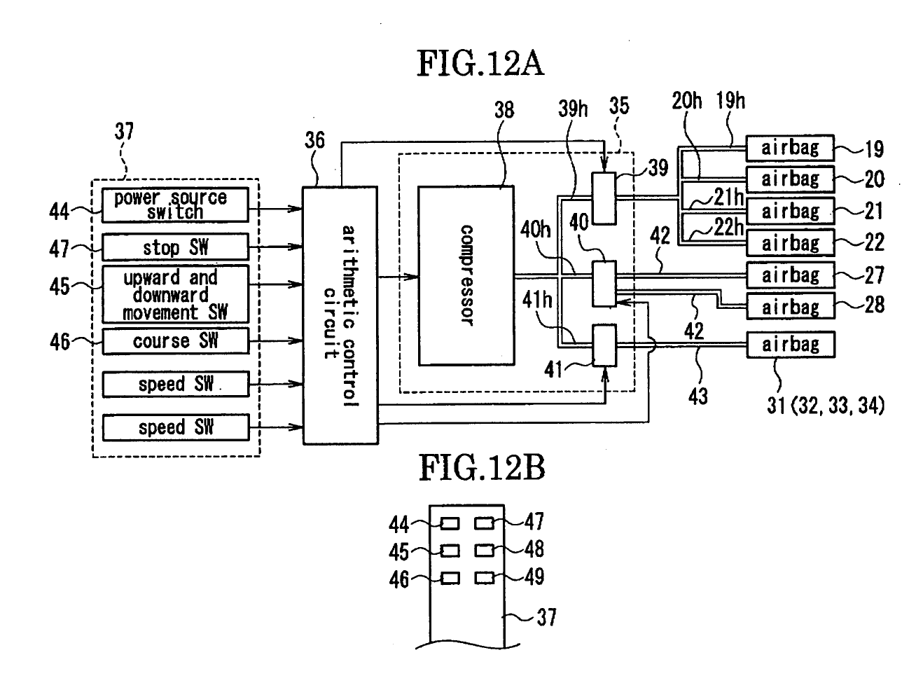

Furthermore, the massaging apparatus 2 includes an air supply-exhaust means 35 shown in FIG. 12(a), an arithmetic control circuit 36, and a remote control 37 shown in FIGS. 1 and 12(b).

(Air Supply-Exhaust Means 35)

The air supply-exhaust means 35 includes an air compressor 38 as an air supply source operated and controlled by the arithmetic control circuit 36 and air supply-exhaust valves 39, 40 and 41, as shown in FIG. 12 (a). Each of the air-exhaust valves 39, 40 and 41 has three first, second and third ports which are not shown. The first ports of the air supply-exhaust valves 39, 40 and 41 are connected to an air discharge outlet (not shown) of the air compressor 38 through air hoses 39h, 40h and 41h. The second port (not shown) of the air supply-exhaust valve 39 is connected through air hoses 19h to 22h to the air bags 19 to 22, the second port (not shown) of the air supply-exhaust valve 40 is connected through air hoses 42 to the airbags 27 and 28, the second port (not-shown) of the air-supply exhaust valve 41 is connected through an air hose 43 to the airbags 31 to 34 of the lifting and lowering drive means 30. In addition, the third port of each of the air supply-exhaust valves 39, 40 and 41 is opened to the atmosphere.

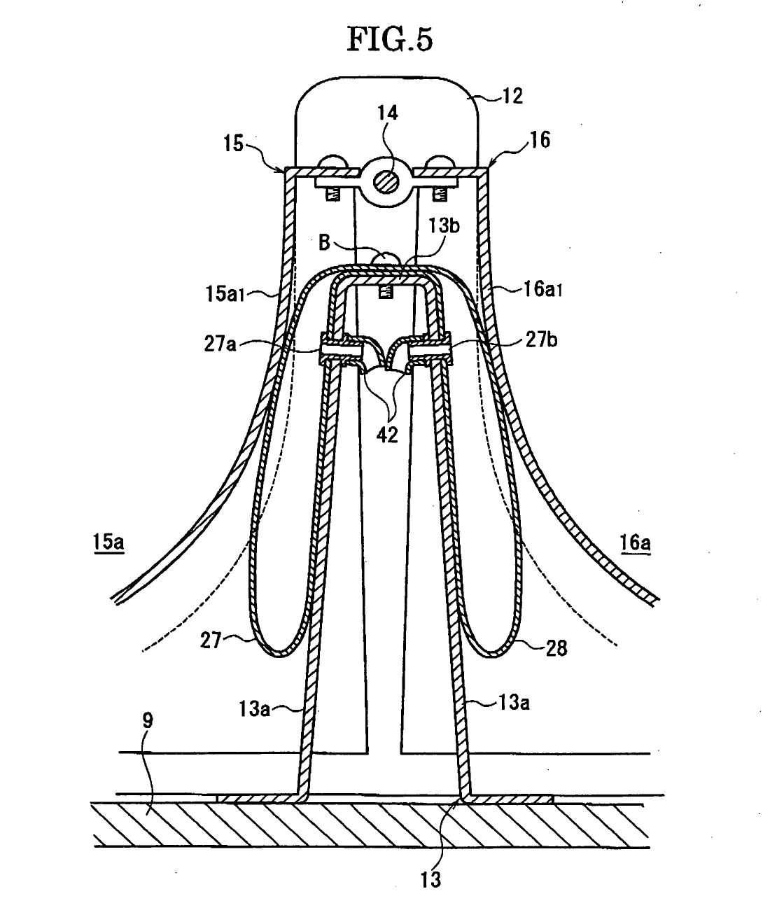

Meanwhile, the airbags 27 and 28 are provided with hose connecting pipes 27a and 28a, respectively, which are disposed adjacent the top wall 13e of the bag supporting member 13 and pass through the side walls 13a and 13a, as shown in FIG. 5. The hose connecting pipes 27a and 28a fix the airbags 27 and 28 to the side walls 13a and 13a at a position in the vicinity of the top portion 13b. The air hoses 42 are connected to the hose connecting pipes 27a and 28a.

Moreover, well-known valves such as three-way changing electromagnetic valves or rotary valves or the like in which one of air discharging ports is opened to the atmosphere may be used as the air supply-exhaust valves 30, 40 and 41.

The arithmetic control circuit 36 operates and controls the air supply-exhaust valve 39 to communicate the first and second ports of the air supply-exhaust valve 39 with each other and allow the air compressor 38 to communicate with the airbags 19 to 22 through the air hose 39h, the air supply-exhaust valve 39 and the air hoses 19h to 22h, thereby air from the air compressor 38 can be supplied to the airbags 19 to 22.

Moreover, the arithmetic control circuit 36 operates and controls the air supply-exhaust valve 39 to communicate the first and second ports of the air supply-exhaust valve 39 with each other and allow the air compressor 38 to communicate with the airbags 19 to 22 through the air hose 39h, the air supply-exhaust valve 39 and the air hoses 19h to 22h, thereby air from the air compressor 38 can be supplied to the airbags 19 to 22.

In addition, the arithmetic control circuit 36 operates and controls the air supply-exhaust valve 39 to communicate the second and third ports of the air supply-exhaust valve 39 with each other and allow the airbags 19 to 22 to communicate with the atmosphere through the air hoses 19h to 22h and the air supply-exhaust valve 39, thereby air in the airbags 19 to 22 can be discharged to the atmosphere.

Moreover, the arithmetic control circuit 36 operates and controls the air supply-exhaust valve 40 to communicate the first and second ports of the air supply-exhaust valve with each other and allow the air compressor 38 to communicate with the airbags 27 and 28 through the air hose 40h, the air supply-exhaust valve 40 and the air hoses 42, 42, thereby air from the air compressor 38 can be supplied to the airbags 27 and 28.

In addition, the arithmetic control circuit 36 operates and controls the air supply-exhaust valve 40 to communicate the second and third ports of the air supply-exhaust valve 40 with each other and allow the airbags 27 and 28 to communicate with the atmosphere through the air hoses 42, 42 and the air supply-exhaust valve 40, thereby air in the airbags 27, 28 can be discharged to the atmosphere.

Furthermore, the arithmetic control circuit 36 operates and controls the air supply-exhaust valve 41 to communicate the first and second ports of the air supply-exhaust valve 41 with each other and allow the air compressor 38 to communicate with the airbags 31 to 34 through the air hose 41h, the air supply-exhaust valve 41 and the air hose 43, thereby air from the air compressor 38 can be supplied to the airbags 31 to 34.

In addition, the arithmetic control circuit 36 operates and controls the air supply-exhaust valve 41 to communicate the second and third ports of the air supply-exhaust valve 41 with each other and allow the airbags 31 to 34 to communicate with the atmosphere through the air hose 43 and the air supply-exhaust valve 41, thereby air in the airbags 31 to 34 can be discharged to the atmosphere.

Furthermore, the arithmetic control circuit 36 operates and controls the air supply-exhaust valve 41 to block the communication of the second port and the first and third ports of the air supply-exhaust valve 41.

(Remote Control 37)

The remote control 37 includes a power source switch 44, an upward movement switch 45U and a movable switch 45L which for driving the leg rest (swinging the leg rest), a course switch 46 for a course massage, a stop switch 47, a speed up switch 48, and a speed down switch 49. These switches 44 to 49 are connected with the arithmetic control circuit 36.

[Operation]

Next, an operation of the massaging apparatus 2 having the above structure and attached to the chair 1 is explained.

(1) Lifting and Lowering (Upward and Downward) Manipulation for the Leg Rest 8

In the above-mentioned structure, the leg rest 8 is, when it is not used, placed in a state of 0° to a perpendicular axis state (the lower thigh-location grooves 15a, 16a extend perpendicularly and are opened forwardly) as shown in FIG. 8.

In this position, a user seats on the chair 1 and inserts the right and left legs in the lower thigh-location grooves 15a and 16a from the cover 29, and turns ON the power source switch 44 of the remote control 37 to drive the arithmetic control circuit 36.

In this state, when the upward movement switch 45U for driving the leg rest provided in the remote control 37 is pressed, the arithmetic control circuit 36 operates the compressor 38. Also, at this time, the arithmetic control circuit. 36 operates and controls the air supply-exhaust valves 41 to communicate the first and second ports of the air supply-exhaust valves 41 with each other and to allow the outlet of the air compressor 38 to communicate with the airbags 31 to 34. Thereby, the air from the air compressor 38 is supplied through the air hose 41h, the air supply-exhaust valve 41 and the air hose 43 to the airbags 31 to 34 to inflate them.

The airbags 31 to 34 are inflated during pressing the upward movement switch 45U, and they are configured to be optionally inflated from a state shown in FIG. 8 to a state shown in FIGS. 9 to 11. Thereby, leg rest 8 is configured to be swung optionally between the state of 0° about the supporting shaft 11 to the perpendicular axis as shown in FIG. 8 and the state (approximately horizontal state) of about 90° to the perpendicular axis as shown in FIGS. 9 to 11.

On the other hand, when the downward movement switch 45L for driving the leg rest provided in the remote control 37 is pressed, the arithmetic control circuit 36 stops the operation of the compressor 38. Also, at this time, the arithmetic control circuit 36 operates and controls the air supply-exhaust valve 41 to communicate the second and third ports of the air supply-exhaust valve 41 with each other and allow the airbags 31 to 34 to communicate with the atmosphere. Thereby the air in the airbags 31 to 34 is discharged to the atmosphere through the air hose 43 and the air supply-exhaust valve 41 to deflate the airbags 31 to 34.

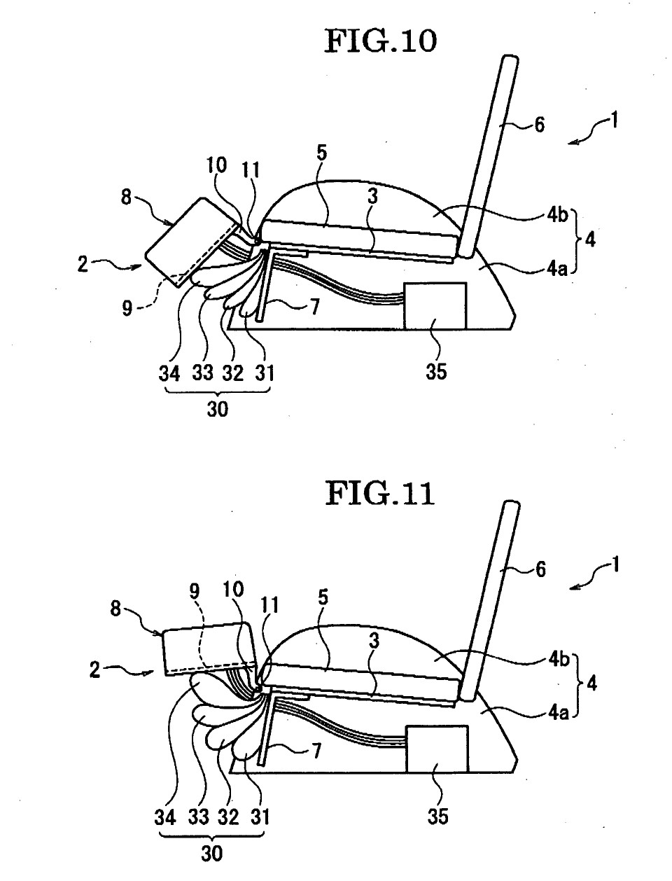

The airbags 31 to 34 are deflated optionally from a state shown in FIG. 11 to a state shown in FIGS. 8 to 11 during pressing the downward movement switch 45L. Thereby, the leg rest 8 is configured to be swung optionally between the state (approximately horizontal state) of about 90° about the supporting shaft 11 to the perpendicular axis as shown in FIG. 11 and the state of 0° to the perpendicular axis as shown in FIGS. 10 to 8.

(2) Course Massage

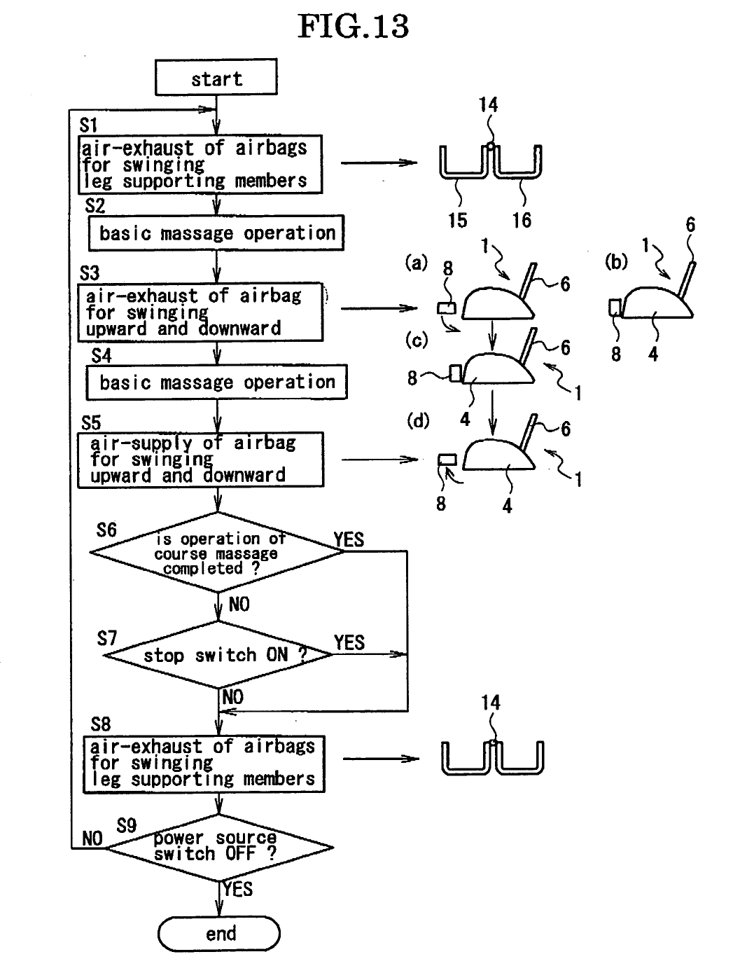

Moreover, the arithmetic control circuit 36 operates and controls, when the switch 46 for the course massage in the remote control 37 is pressed, the air compressor 36 and the air supply-exhaust valves 39, 40 and 41 in accordance with the a flow chart shown in FIG. 13. Here, the operation and the control of the arithmetic control circuit are explained by showing the states of the leg supporting members 15, 16 and the leg rest 8 at the right side of the flow chart to correspond to steps in the flow chart.

Step S1

That is to say, the arithmetic control circuit 36 operates and controls, when it is started by the switch 46 being pressed, the air supply-exhaust valve 40 for the airbags 27 and 28 for swinging the leg supporting members in the step S1 to communicate the second and third ports of the air supply-exhaust valve 40 with each other and to communicate the airbags 27 and 28 through the air supply-exhaust valve 40 with the atmosphere. Thereby, the air in the airbags 27 and 28 is discharged to the atmosphere, the process is shifted from the step S1 to step S2 in a state where the leg supporting members 15 and 16 have no angle as shown in the right side of the flow chart.

Step S2

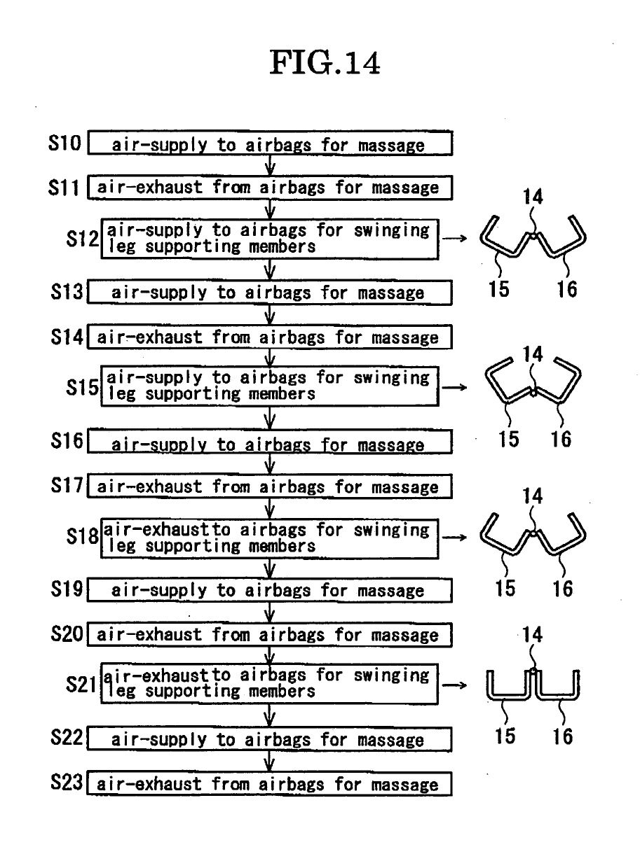

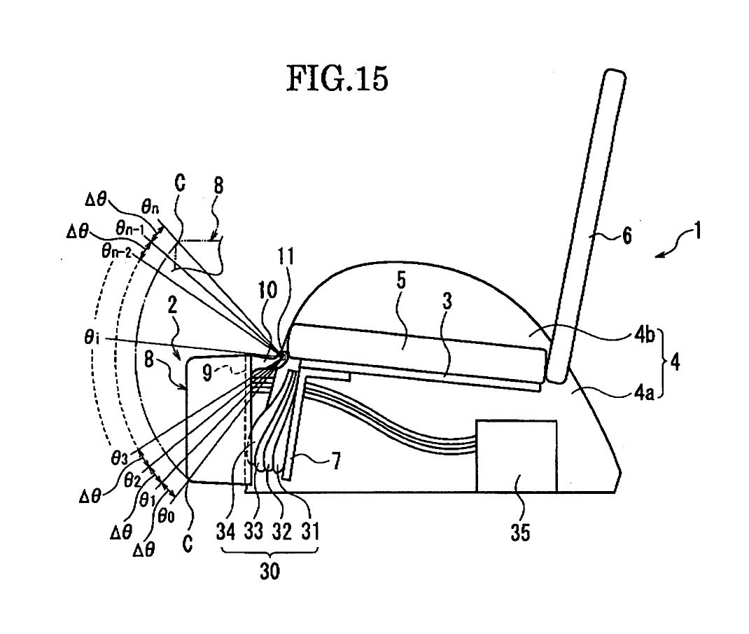

In the step S2, a basic massaging process shown in steps S10 to S23 in FIG. 14 is executed.

<Basic Massaging Operation>

Step S10

In the step S10, the arithmetic control circuit 36 operates the air compressor 38, and operates and controls the air supply-exhaust valve 39 to communicate the first and second ports of the air supply-exhaust valve 39 with each other. Thereby, the air from the air compressor 38 is supplied to the massaging airbags 19 to 22 to inflate the airbags 19 to 22, as describe above. Consequently, the user's left lower thigh is pressed by the airbags 19 and 20 with the state where the left lower thigh is held between the airbags. In addition, the user's right lower thigh is pressed by the airbags 21 and 22 with the state where the right lower thigh is held between the airbags. When the pressed operation for the right and loft lower thighs is completed, the arithmetic control circuit 36 controls the process to shift to step S11.

Step S11

In the step S11, the arithmetic control circuit 36 stops the air compressor 38, and operates and controls the air supply-exhaust valve 39 to communicate the second and third ports of the air supply-exhaust valve 39 with each other and discharge the air from the airbags 19 to 22 to the atmosphere as described above, thus to deflate the airbags 19 to 22. Thereby, a holding force of the airbags 19 and 20 holding the user's left lower thigh is released and a holding force of the airbags 21 and 22 holding the user's right lower thigh is released. When the operation is completed, the arithmetic control circuit 36 controls the process to shift to step S12.

Step S12

In the step S11, the arithmetic control circuit 36 operates the air compressor 38 by a predetermined time and operates and controls the air supply-exhaust valve 40 to communicate the first and second ports of the air supply-exhaust valve 40 with each other, in addition, to supply the air from the air compressor 38 to the airbags 27 and 28 for swinging the leg supporting members as described above and to inflate the airbags 27 and 28 by a predetermined amount (for example, half of the total inflating amount). Thereafter, the arithmetic control circuit 36 further operates and controls the air supply-exhaust valve 40 to block the communication of the second port of the air supply-exhaust valve with the first and third ports. Thereby, the communication of the airbags 27, 28 with the air compressor 38 and the atmosphere is in a blocked state.

By inflation of the airbags 27 and 28, the leg supporting members 15 and 16 for supporting the user's lower thighs are rotated by about half of the maximum swinging amount about the supporting shaft 14, the process is shifted to step S13.

Step S13

In the step S13, the arithmetic control circuit 36 operates the air compressor 38, and operates and controls the air supply-exhaust valve 39 to communicate the first and second ports of the air supply-exhaust valve 39 with each other and to supply the air from the air compressor 38 to the massaging airbags 19 to 22 as described above, whereby inflating the airbags 19 to 22.

Consequently, the user's left lower thigh is pressed by the airbags 19 and 20 in the state where the left lower thigh is held between the airbags at a different position from the step S10, and the user's right lower thigh is pressed by the airbags 21 and 22 in the state where the right lower thigh is held between the airbags at a different position from the step S10.

When the above-mentioned pressed operation for the right and left lower thighs is completed, the arithmetic control circuit 36 controls the process to shift to step S14.

Step S14

In the step S14, the arithmetic control circuit 36 stops the air compressor 38, and operates and controls the air supply-exhaust valve 39 to communicate the second and third ports of the air supply-exhaust valve 39 with each other and discharge the air from the airbags 19 to 22 to the atmosphere as described above, thus to deflate the airbags 19 to 22. Thereby, the holding force of the airbags 19 and 20 holding the user's left lower thigh is released and the holding force of the airbags 21 and 22 holding the user's right lower thigh is released. When the operation is completed, the arithmetic control circuit 36 controls the process to shift to step S15.

Step S15

In the step S15, the arithmetic control circuit 36 further operates the air compressor 38 by a predetermined time and operates and controls the air supply-exhaust valve 40 to communicate the first and second ports of the air supply-exhaust valve 40 with each other, in addition, to supply the air from the air compressor 38 to the airbags 27 and 28 for swinging the leg supporting members as described above and to inflate the airbags 27 and 28 to a maximum extent. Thereafter, the arithmetic control circuit 36 further operates and controls the air supply-exhaust valve 40 to block the communication of the second port of the air supply-exhaust valve with the first and third ports. Thereby, the communication of the airbags 27, 28 with the air compressor 38 and the atmosphere is in a blocked state.

By inflation of the airbags 27 and 28, the leg supporting members 15 and 16 for supporting the user's left lower thigh are rotated the maximum swinging amount about the supporting shaft 14, after the lower thigh-location grooves 16a and 16a of the log supporting members 15 and 16 are disposed to face in the inclined and opposed state, the process is shifted to step S16.

Step S16

In the step S16, the arithmetic control circuit 36 operates the air compressor 38, and operates and controls the air supply-exhaust valve 39 to communicate the first and second ports of the air supply-exhaust valve 39 with each other and to supply the air from the air compressor 38 to the massaging airbags 19 to 22 as described above, whereby inflating the airbags 19 to 22.

Consequently, the user's left lower thigh is pressed by the airbags 19 and 20 in the state where the left lower thigh is held between the airbags at a different position from the steps S10 and S13, and the user's right lower thigh is pressed by the airbags 21and 22 in the state where the right lower thigh is held between the airbags at a different position from the steps S10 and S13.

When the above-mentioned pressed operation for the right and left lower thighs is completed, the arithmetic control circuit 36 controls the process to shift to step S17.

Step S17

In the step S17, the arithmetic control circuit 36 stops the air compressor 38, and operates and controls the air supply-exhaust valve 39 to communicate the second and third ports of the air supply-exhaust valve 39 with each other and discharge the air from the airbags 19 to 22 to the atmosphere as described above, thus to deflate the airbags 19 to 22. Thereby, the holding force of the airbags 19 and 20 holding the user's left lower thigh is released and the holding force of the airbags 21 and 22 holding the user's right lower thigh is released. When the operation is completed, the arithmetic control circuit 36 controls the process to shift to step S18.

Step S18

In the step S18, the arithmetic control circuit 36 stops the air compressor 38 by a predetermined time and operates and controls the air supply-exhaust valve 40 to communicate the second and third ports of the air supply-exhaust valve 40 with each other, and to discharge the air from the airbags 27 and 28 for swinging the leg supporting members to the atmosphere by half of the maximum amount, whereby deflating the airbags 27 and 28 by the half amount. Thereafter, the arithmetic control circuit 36 further operates and controls the air supply-exhaust valve 40 to block the communication of the second port of the air supply-exhaust valve with the first and third ports. Thereby, the communication of the airbags 27, 28 with the air compressor 38 and the atmosphere is in a blocked state.

By deflation of the airbags 27 and 28, the leg supporting members 15 and 16 for supporting the user's left lower thigh are rotated by about half of the maximum swinging amount about the supporting shaft 14 in a direction of returning to the original state and stopped, the process is shifted to step S19.

Step S19

In the step S19, the arithmetic control circuit 36 operates the air compressor 38, and operates and controls the air supply-exhaust valve 39 to communicate the first and second ports of the air supply-exhaust valve 39 with each other and to supply the air from the air compressor 38 to the massaging airbags 19 to 22 as described above, whereby inflating the airbags 19 to 22.

Consequently, the user's left lower thigh, is pressed by the airbags 19 and 20 in the state where the left lower thigh is held between the airbags at the generally same position as the step S13, and the user's right lower thigh is pressed by the airbags 21 and 22 in the state where the right lower thigh is held between the airbags at the generally same position as the step S13.

When the above-mentioned pressed operation for the right and left lower thighs is completed, the arithmetic control circuit 36 controls the process to shift to step S20.

Step S20

In the step S20, the arithmetic control circuit 36 stops the air compressor 38, and operates and controls the air supply-exhaust valve 39 to communicate the second and third ports of the air supply-exhaust valve 39 with each other and discharge the air from the airbags 19 to 22 to the atmosphere as described above, thus to deflate the airbags 19 to 22. Thereby, the holding force of the airbags 19 and 20 holding the user's left lower thigh is released and the holding force of the airbags 21 and 22 holding the user's right lower thigh is released. When the operation is completed, the arithmetic control circuit 36 controls the process to shift to step S21.

Step S21

In the step S21, the arithmetic control circuit 36 stops the air compressor 38, and operates and controls the air supply-exhaust valve 40 to communicate the second and third ports of the air supply-exhaust valve 40 with each other and to discharge most of air from the airbags 27 and 28 for swinging the leg supporting members to the atmosphere, thus to deflate the airbags 27 and 28 to a minimum extent. By deflation of the airbags 27 and 28, the leg supporting members 15 and 16 for supporting the user's left lower thigh are rotated about the supporting shaft 14, and returned to an initial position shown in the step S1 to shift to step S22.

Step S22

In the step S22, the arithmetic control circuit 36 operates the air compressor 38, and operates and controls the air supply-exhaust valve 39 to communicate the first and second ports of the air supply-exhaust valve 39 with each other and to supply the air from the air compressor 38 to the massaging airbags 19 to 22 to inflate the airbags 19 to 22, as describe above. Consequently, the user's left lower thigh is pressed by the airbags 19 and 20 with the state where the left lower thigh is held between the airbags at the generally same position as the step S10. In addition, the user's right lower thigh is pressed by the airbags 21 and 22 with the state where the right lower thigh is held between the airbags at the generally same position as the step S10. When the pressed operation for the right and left lower thighs is completed, the arithmetic control circuit 36 controls the process to shift to step S23.

Step S23

In the step S23, the arithmetic control circuit 36 stops the air compressor 38, and operates and controls the air supply-exhaust valve 39 to communicate the second and third ports of the air supply-exhaust valve 39 with each other and discharge the air from the airbags 19 to 22 to the atmosphere as described above, thus to deflate the airbags 19 to 22. Thereby, the holding force of the airbags 19 and 20 holding the user's left lower thigh is released and the holding force of the airbags 21 and 22 holding the user's right lower thigh is released. When the operation is completed, the arithmetic control circuit 36 controls the process to shift to step S3.

Step S3

In the step S3, the arithmetic control circuit 36 operates and controls the air supply-exhaust valve 41 regardless of whether the leg rest 8 is in a vertical state as shown in (b) at the right side or a horizontal state as shown in (a) to discharge the air in the airbags 31 to 34 for swinging up and down the leg rest to the atmosphere, as described above, whereby orientating the leg rest 8 perpendicularly as shown in (c), then the process is shifted to step S4.

Step S4

In the step S3, the arithmetic control circuit 36 executes the basic massaging operation in the steps S10 to S23 and shifts the process to step S5.

Step S5

In the step S3, the arithmetic control circuit 36 operates the air compressor 38, and operates and controls the air supply-exhaust valve 41 to communicate the first and second ports of the air supply-exhaust valve 41 with each other and to supply the air to the airbags 31 to 34 for swinging up and down the leg rest, as described above, thus to inflate the airbags 31 to 34. Thereby, the leg rest 8 is swung upwardly until it is in the horizontal state as shown in (d). In addition, the arithmetic control circuit shifts the process to step S6.

Step S6

In the step S6, the arithmetic control circuit 36 determines whether the operation of the course massage is completed. In the determination, if the operation of the course massage is not completed, the process is shifted to step S7. If the operation numbers for the massage set in the steps S1 to S5 are executed and the operation of the massage is completed, the process is shifted to step S8.

Step S7

In the step S7, the arithmetic control circuit 36 determines whether the stop switch 47 is pressed. If the stop switch 47 is not pressed, the step is shifted to the step S8, if it is pressed, the process is shifted to the step S8.

Step S8

Meanwhile, in each process from the basic massage operation in the steps S1 and S2 (each process in steps S1 to S23) to the step S5, the arithmetic control circuit 36 determines constantly whether the stop switch 47 is pressed during each step is completed. When the arithmetic control circuit determines that the stop switch 47 is pressed, the process is shifted to the step S8.

In the step S8, the arithmetic control circuit 36 stops the air compressor 38, and allows the airbags 27 and 28 for swinging the leg supporting members to communicate through the air supply-exhaust valve 40 with the atmosphere to discharge the air in the airbags 27 and 28. Thereby, the leg supporting members 15 and 16 are disposed in a state having no angle as shown at the right side of the flow chart, then the process is shifted to step S9.

In this case, it is also possible to release the holding force of the airbags 19 and 20 holding the user's left lower thigh and the holding force of the airbags 21 and 22 holding the user's right lower thigh by operating and controlling the air supply-exhaust valve 39 to communicate the second and third ports of the air supply-exhaust valve with each other, and discharging the air in the airbags 19 to 22 to the atmosphere as described above to deflate the airbags 19 to 22.

Step S9

In the step S9, the arithmetic control circuit 36 determines whether the power source switch 44 is pressed. If the power source switch 44 is not pressed, the process is returned to the step S1 to make a loop, if it is pressed, the process is completed.

If the process is shifted from the step S9 through the step S1 to the basic massage operation in the step S2, the leg rest 8 is in the generally horizontal state. Also, if the basic massage operation in the step S4 through the step S3 is executed, the leg rest 8 is in the perpendicularly directed state. Therefore, in the massage operation in the step S2 and the basic massage operation in the step S4, the massage positions of the user's lower thighs by the airbags 19 to 22 are different longitudinally of the lower thighs.

In other words, the massage locations of the user's lower thighs to which the airbags 19 to 22 executes in the massage operation in the step S2 are positions lower than that of the user's lower thighs massaged by the airbags 19 to 22 in the massage operation in the step S 4. Meanwhile, because the airbags 19 to 22 have a certain extension (area), there is a case in which the massage locations are common in the steps S2 and S4.

As described above, the first massaging apparatus in the mode according to the present invention comprises the treated part-mounting table or leg rest 8 including the supporting members or leg supporting members 15 and 16 which have the grooves or lower thigh-location grooves 15a and 16a in which the user's treated parts (lower thighs) are disposed and are adapted to be rotatable peripherally of the grooves or lower thigh-location grooves 15a and 16a, and the rotational means or airbags 27 and 28 for rotating the supporting members or leg supporting members 15 and 16 peripherally of the grooves or lower thigh-location grooves 15a and 16a.

Moreover, the massaging apparatus comprises massagers or the airbags 19 to 22 provided in the grooves or lower thigh-location grooves 16a and 16a, means or air supply-exhaust means 35 for operating the massagers and massaging the treated parts or lower thighs by the massagers or airbags 19 to 22, and control means or the arithmetic control circuit 36 for operating and controlling the rotational means or airbags 27, 28 and the massager operating means or air supply-exhaust means 35.

Furthermore, the control means or arithmetic control circuit 36 of the massaging apparatus operates the massager operating means or air supply-exhaust means to massage the treated parts or lower thighs by the massagers or airbags 19 to 22 while operating the rotational means or airbags 27 and 28 to rotate the supporting members or leg supporting members 15 and 16 peripherally of the grooves or lower thigh-location grooves 15a and 16a.

With this structure, because the user's treated parts or lower thighs are massaged while rotating the leg supporting members 15 and 16, the massage positions of the user's treated parts or lower thighs can be changed peripherally of the treated parts or lower thighs.

In addition, in the embodiment, the airbags 19 to 22 as the massagers arc used, but the massagers are not limited to the airbags 19 to 22. For example, at least one acupressure member operated by a vibrator or drive means may be used as a massager. In this case, the acupressure member may be structured to press to the lower thighs by use of a mechanical drive mechanism for converting rotation of a drive motor into reciprocating motion. Moreover, in this embodiment, although the airbags 27 and 28 are used as the rotational means, the rotational means is necessarily not limited to the airbags. For example, as the rotational means an actuator such as a solenoid, an air cylinder, an oil cylinder, a mechanical structure in which a drive motor and a reduction mechanism are combined, or the like may be used.

Furthermore, in this embodiment, the rotational movement of the leg supporting members 15 and 16 by the rotational means or airbags 27 and 28 and the operation (inflation and deflation of the airbags 19 to 22) of the massagers or airbags 19 to 22 are alternately executed, but without being limited to this, the rotational movement and the operation may be executed randomly, for example.

Here, the rotational movement includes either of continuous rotational movement and intermittent rotational movement. In addition, in the intermittent rotational movement, when the intermittent rotational movement occurs continuously several times in a series of operations, such a continuous intermittent rotational movement is considered as continuous rotational movement.

Moreover, in the second massaging apparatus in the mode, the massager includes the airbag 19 or 20, 21 or 22 attached to at least one of the side walls 15a1 and 15a2 facing the grooves or lower thigh-location grooves 16a and 16a, the massager operating means or airbags 19 to 22 include the air supply-exhaust means 35 which supplies air to and exhausts air from the airbag 19 or 20, 21 or 22 to inflate or deflate the airbag 19 or 20, 21 or 22.

In addition, the control means or arithmetic control circuit 36 controls the rotational means or airbags 27 and 28 to execute the rotational operation when the airbag 19 or 20, 21 or 22 is in an air exhausted state (deflated), and stop the rotational operation when the airbag 19 or 20, 21 or 22 is in an air supplied state (inflated). Thereby, the treated parts or lower thighs are massaged intermittently by the airbags 19 to 22 while rotating intermittently the supporting members or leg supporting members 15 and 16 peripherally of the grooves or the lower thigh-location grooves 16a and 16a.

With the structure, because the leg supporting members 15 and 16 are rotated in a state where the airbag 19 or 20, 21 or 22 do not press the user's lower thighs, the massaged positions of the lower thighs can be changed peripherally of the lower thighs without placing a burden on the user's lower thighs.

### MODIFIED EXAMPLE 1

Furthermore, in another massaging apparatus in the mode, the massager may include the airbag 19 or 20, 21 or 22 attached to the at least one of the side walls 15a1 and 15a2 (at least one of the side walls 16a1 and 16a2) facing the grooves or lower thigh-location grooves 15a and 16a, and the massager operating means or airbags 19 to 22 may include the air supply-exhaust means 36 which supplies air to and exhausts air from the airbag 19 or 20, airbag 21 or 22 to inflate or deflate the airbag 19 or 20, airbag 21 or 22. Also, in addition thereto, the control means or arithmetic control circuit 36 controls the rotational means or airbags 27 and 28 to execute the rotational operation when the airbag 19 or 20, 21 or 22 is in an air supplied state (inflated). Thereby, the treated parts or lower thighs can be massaged by the airbag 19 or 20, the airbag 21 or 22.

With.the structure, to the contrary, because the leg supporting members 15 and 16 are rotated peripherally of the lower thigh-location grooves 16a and 16a in a state where the user's lower thighs are held by the airbag 19 or 20, 21 or 22, a torsion operation of the lower thighs in addition to the massaged positions of the lower thighs is executed.

### MODIFIED EXAMPLE 2

Moreover, in the first and second massaging apparatus in the mode, the treated part-mounting table is the log rest 8 upwardly and downwardly rotatably attached to a lower portion of the front end of the seat 5 of the chair 1. A rest drive means 30 is provided to drive upwardly and downwardly the leg rest 8, the control means or arithmetic control circuit 36 operates the rest drive means 30 to drive upwardly and downwardly the leg rest 8 whereby enabling to execute the massage of the lower thighs.

With the structure, the massaged positions on the user's lower thighs can be moved longitudinally of the lower thighs while swinging the user's lower thighs upwardly and downwardly, and because the user's lower thighs are massaged while rotating the leg supporting members 15 and 16, the massaged positions on the user's lower thighs can be changed peripherally of the lower thighs.

### MODIFIED EXAMPLE 3

As mentioned above, although the massaging apparatus 2 is attached to lower portion of the front end of the seat of the chair 1 and configured to execute the massage for the user's right and left lower thighs simultaneously, the right and left lower thighs may be massaged separately, or alternately.

In addition, the massaging apparatus 2 can be applied to a massaging chair having an airbag provided on a surface of a seat or backseat of the chair contacting with a person.

Furthermore, the right and left leg supporting members 15 and 16 may be attached rotatably peripherally to the separate arm rests so as to act as arm supporting members, and backward portions of the two rests may be attached rotatably upwardly and downwardly to right and left arm rests of the chair, respectively to massage the right and left arms by the right and left arm supporting members in the same operation as mentioned above.

The leg rest having the above-mentioned leg supporting members 15 and 16 and the arm rest having the arm supporting members (the same structure as the leg supporting members) can be applied for a mat type-massaging apparatus.

### MODIFIED EXAMPLE 4

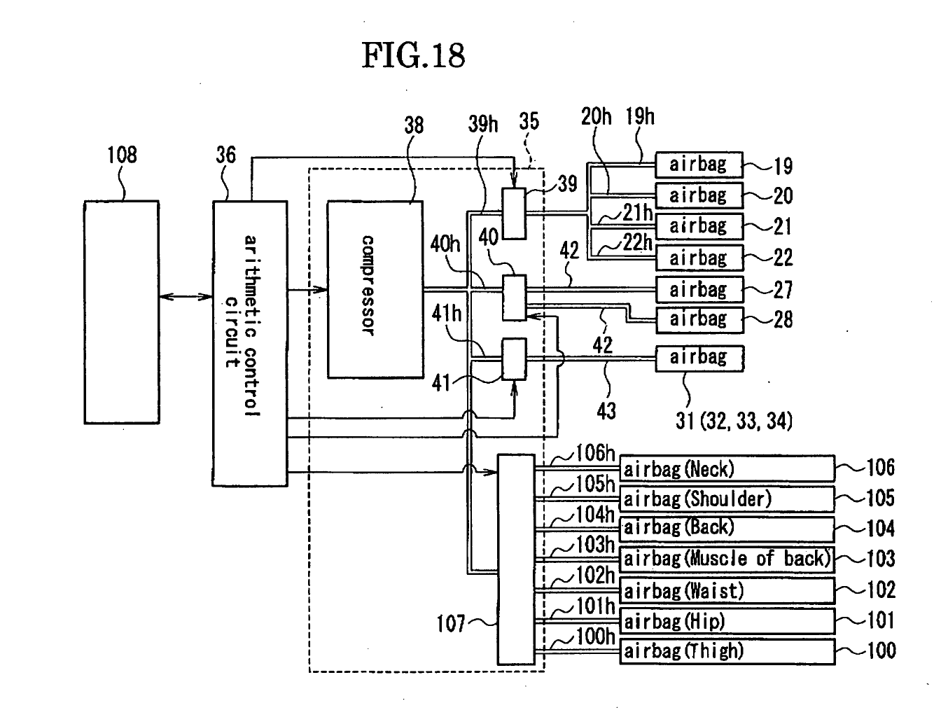

In the course massage (2) in the embodiment as mentioned above, the basic massage operation shown in the steps S10 to 23 is adapted to be executed in a state where the leg rest 8 is disposed perpendicularly as shown in FIG. 18(c), but without being limited to this necessarily another operation may be used.

For example, while repeating the lifting rotation and the lowering rotation (lesser than the lifting rotation) of the leg rest 8 alternately, finally, the leg rest 8 may be rotated upwardly from a downwardly directed state to a horizontal state, or while repeating the lowering rotation and the lifting rotation (lesser than the lowering rotation) of the leg rest 8 alternately, the leg rest 8 may be rotated downwardly from the horizontal state to the downwardly directed state.

In other words, after the basic massage operation in the steps S 10 to S23 is executed by driving the leg rest 8 by a predetermined amount X1 upwardly, if an operation of executing the basic massage operation in the steps S10 to S23 by driving the leg rest 8 by a predetermined amount X2 lesser than the predetermined amount X1 is an upward swinging massage operation, the upward swinging massage operation may be executed in a range where the leg rest 8 is moved from the perpendicularly directed state as shown in FIG. 13(c) to the horizontal state as shown in FIG. 13(d). In addition, to the contrary, the lowering swinging massage operation may be executed.

Next, this embodiment is explained. Here, for convenience on a description, assuming that the a rotational angle of a corner C at the lower portion of the frond end of the leg rest 8 about the supporting shaft 11 is θi (i=0, 1, 2, 3 . . . n), the description is made. That is to say, the description is made dividing a range from the rotational angle θ0 in the lowermost end when the leg rest 8 is perpendicularly downwardly disposed as shown in FIG. 13(b) to the rotational angle θn in the uppermost end when the leg rest 8 is horizontally disposed as shown in FIG. 13(c) into n by a predetermined angle Δθ.

(i) Massage by the Upward Swinging Operation of the Leg Rest 8

<Massage in the Rotational Angles θ1 and θ2>

The arithmetic control circuit 36 first operates the air compressor 38 and operates and controls the air supply-exhaust valve (air supply-exhaust means) 41 to communicate the first and second ports of the air supply-exhaust valve 41 with each other and supply a predetermined amount of air to the airbags 81 to 34 for lifting and lowering to inflate the airbags a predetermined amount, whereby swinging the leg rest 8 upwardly by a predetermined angle, for example, 3Δθ which is in a range from the rotational angle θ0 to a rotational angle θ3. At this position, the arithmetic control circuit 36 operates and controls the air supply-exhaust valve 41 to block the communication of the second port of the air supply-exhaust valve with the first and third ports, whereby stopping the leg rest 8 at the position of the rotational angle θ3.

On the other hand, the arithmetic control circuit 36 executes the basic massage operation in the steps S10 to S23 shown in FIG. 14 as described above in the state where the leg rest 8 is in the position of the rotational angle θ3 to massage the user's left lower thigh holding it by the airbags 19 and 20, and the user's right lower thigh holding it by the airbags 21 and 22.

Next, the arithmetic control circuit 36 operates and controls the air supply-exhaust valve (air supply-exhaust means) 41 to block the communication of the first port of the air supply-exhaust valve 41 with the second port and communicate the second and third ports of the air supply-exhaust valve with each other, and communicate the airbags 31 to 34 for lifting and lowering with the atmosphere to discharge a predetermined amount of air in the airbags 31 to 34 to the atmosphere, whereby swinging the leg rest 8 downwardly by a predetermined angle, for example, 2Δθ which is in a range from the rotational angle θ3 to the rotational angle θ1.

At this position, the arithmetic control circuit 36 operates and controls the air supply-exhaust valve 41 to block the communication of the second port of the air supply-exhaust valve 41 with the first and third ports to stop the leg rest 8 at the position of the rotational angle θ1. Then, the arithmetic control circuit 36 executes the basic massage operation in the steps S10 to S23 shown in FIG. 14 as described above in the state where the leg rest 8 is in the position of the rotational angle θ3 to massage the user's left lower thigh holding it by the airbags 19 and 20, and the user's right lower thigh holding it by the airbags 21 and 22.

In this way, the arithmetic control circuit 36 executes the massage of the lower thighs at the position where the leg rest 8 is swung upwardly by 3Δθ, thereafter executes the massage of the lower thighs at the position where the leg rest 8 is swung downwardly by 2Δθ. In addition, the arithmetic control circuit executes repeatedly this operation until the leg rest 8 becomes approximately the horizontal state or the rotational angle θn.

(ii) Massage by the Lowering Swinging Operation of the Leg Rest 8

Moreover, when swinging the leg rest 8 downwardly, after the massage of the lower thighs is executed at the position where the leg rest 8 is swung downwardly by 3Δθ, the massage of the lower thigh is executed at the position where the leg rest 8 is swung upwardly by 2Δθ. In addition, the arithmetic control circuit 36 executes this operation repeatedly until the leg rest 8 is in the generally perpendicularly directed state of the rotational angle θ0.

By executing the upward swinging massage operation in the (i) like this, because massage points on calves of the lower thighs are changed from lower sides to upper sides of the lower thighs, the massage points of the calves of the lower thighs can be moved from the lower sides to the upper sides, and the massage is not monotonous and advantageous effects of the massage are increased.

As mentioned above, in the massaging apparatus in the mode, the control means or arithmetic control circuit 36 drives the leg rest 8 by a predetermined amount in one direction of the upward and downward movements to execute the massage, thereafter drives the leg rest 8 by an amount lesser than the predetermined amount in the opposite direction to the one direction to repeat an operation of executing the massage in a predetermined range.

With the structure, because the massage points of the calves of the lower thighs are changed longitudinally of the lower thighs, the massage on the entire calves of the lower thighs can be executed and the massage is not monotonous and advantageous effects of the massage are increased.

(iii) Others

Meanwhile, the moving operation to the rotational angle θi at the time of lifting and lowering the leg rest 8 as mentioned above and the stopping operation of the moving operation may be accomplished depending on a supplied amount of air to the airbags 31 to 34, in other words, a supplied time of air, or by detecting the rotational angle of the leg rest 8 by a sensor (for example, a rotary encoder, micro-switch, optical sensor which a combination of a light emitting element and a light receiving element, or the like).

### MODIFIED EXAMPLE 5

In the course massage of (2) in the embodiment as mentioned above, after the leg supporting members 15 and 16 are rotated about the supporting shaft 14 in a closed direction by inflation of the airbags 27 and 28, the leg supporting members 15 and 16 are rotated about the supporting shaft 14 in an opened direction by deflation of the airbags 27 and 28. Here, the rotational operation of the leg supporting members 15 and 16 in the closed and opened directions is divided into two times, but, the rotational operation is not limited to this manner necessarily.

For example, assuming that after rotating the leg supporting members 15 and 16 by a predetermined amount in the closed direction, an operation in which the leg supporting members 15 and 16 are rotated by an amount lesser than the predetermined amount in the opened direction is a basic opening and closing operation, while executing the basic opening and closing operation repeatedly, the massage of the lower thighs may be executed, finally, the leg supporting members 15 and 16 may be configured to rotate from the maximally opened state (180°) to a predetermined angle.

Also, to the contrary, assuming that after rotating the leg supporting members 15 and 16 by a predetermined amount in the opened direction, an operation in which the leg supporting members 15 and 16 are rotated by an amount lesser than the predetermined amount in the closed direction is a basic opening and closing operation, while executing the basic opening and closing operation repeatedly, the massage of the lower thighs may be executed, finally, the leg supporting members 15 and 16 may be configured to rotate from a state of a predetermined angle to the maximally opened state (180°).

Next, the above control is explained.

<Basic Operation>

(a) Closing Operation of the Leg Supporting Members 15 and 16 by the Airbags 27 and 28

The arithmetic control circuit 36 operates the air compressor 38 by a predetermined time and the operates and controls the air supply-exhaust valve 40 to communicate the first and second ports of the air supply-exhaust valve 40 with each other, and supply air from the air compressor 38 to the airbags 27 and 28 for swinging the leg supporting members as described above to inflate the airbags 27 and 28 by an amount. Thereafter, the arithmetic control circuit 36 further operates and controls the air supply-exhaust valve 40 to block the communication of the second port of the air supply-exhaust valve 40 with the first and third ports to block the communication of the airbags 27 and 28 with the air compressor 38 and the atmosphere.

By the inflation of the airbags 27 and 28, the leg supporting members 15 and 16 for supporting the user's lower thighs are rotated by an amount about the supporting shaft 14 in the closed direction.

(b) Opening Operation of the Leg Supporting Members 15 and 16 by the Airbags 27 and 28

The arithmetic control circuit 36 also stops the air compressor 38, and operates and controls the air supply-exhaust valve 40 to communicate the second and third ports of the air supply-exhaust valve 40 with each other, and to discharge air in the airbags 27 and 28 for swinging the leg supporting members to the atmosphere by a predetermined time, to deflate the airbags by an amount. Thereafter, the arithmetic control circuit 36 further operates and controls the air supply-exhaust valve 40 to block the communication of the second port of the air supply-exhaust valve 40 with the first and third ports to block the communication of the airbags 27 and 28 with the air compressor 38 and the atmosphere.

By the inflation of the airbags 27 and 28, the leg supporting members 15 and 16 for supporting the user's left lower thigh are rotated by an amount about the supporting shaft 14 in the opened direction.

(c) Lower Thigh Massaging Operation by the Airbags 19 to 22

The arithmetic control circuit 36 operates the air compressor 38, and operates and controls the air supply-exhaust valve 39 to communicate the first and second ports of the air supply-exhaust valve 39 with each other and to supply the air from the air compressor 38 to the massaging airbags 19 to 22 as described above, whereby inflating the airbags 19 to 22.

Consequently, the user's left lower thigh is pressed by the airbags 19 and 20 in the state where the left lower thigh is held between the airbags, and the user's right lower thigh is pressed by the airbags 21and 22 in the state where the right lower thigh is held between the airbags.

On the other hand, the arithmetic control circuit 36 stops the air compressor 38, and operates and controls the air supply-exhaust valve 39 to communicate the second and third ports of the air supply-exhaust valve 39 with each other and discharge the air from the airbags 19 to 22 to the atmosphere as described above, thus to deflate the airbags 19 to 22. Thereby, the holding force of the airbags 19 and 20 holding the user's left lower thigh is released and the holding force of the airbags 21 and 22 holding the user's right lower thigh is released.

<Control Using the Basic Operations (a) to (c)>

The modified example 5 is structured to execute the closing operation of the leg supporting members 15 and 16 a predetermined amount (predetermined angle) as shown in (a), the massaging operation as shown in (c), thereafter the opening operation of the leg supporting members 15 and 16 by an amount lesser than the predetermined amount (predetermined angle) as shown in (b), and the massaging operation as shown in (c). The opening and closing operations and the massaging operation are executed repeatedly in a predetermined range, in other words, from the state (180°) that the leg supporting members 15 and 16 are opened maximally to the state that the leg supporting members 15 and 16 are in a predetermined angle.

Thereafter, the opening operation of the leg supporting members 15 and 16 a predetermined amount (predetermined angle) is executed as shown in (b), the massaging operation is executed as shown in (c), thereafter the closing operation of the leg supporting members 15 and 16 by an amount lesser than the predetermined amount (predetermined angle) as shown in (b) is executed, and the massaging operation as shown in (c) is executed. The opening and closing operations and the massaging operation are executed repeatedly in a predetermined range in other words, from the state that the leg supporting members 15 and 16 are in the predetermined angle to the state (180°) that the leg supporting members 15 and 16 are opened maximally.

The opening and closing control of the leg supporting members 15 and 16 can be accomplished similarly to the repeating control of the leg rest 8 in the modified example 4.

By executing such an operation, because the massage points of the calves of the lower thighs can be changed peripherally of the lower thighs, the massage is not monotonous and advantageous effects of the massage are increased.

As mentioned above, in the massaging apparatus in the mode, the control means or arithmetic control circuit 36 drives the supporting members or the leg supporting members 15 and 16 by a predetermined amount in one direction of a periphery to execute the massage, thereafter drives the leg supporting members 15 and 16 by an amount lesser than the predetermined amount in the opposite direction to the one direction to repeat an operation of executing the massage in a predetermined range.

With the structure, because the massage points of the calves of the lower thighs are changed peripherally of the low or thighs, the massage points on the calves of the lower thighs can be moved and the massage is not monotonous and advantageous effects of the massage are increased.

### MODIFIED EXAMPLE 6

(a) Closing Operation 1 of the Leg Supporting Members 15 and 16

In the step S12 shown in FIG. 14 as described above, by the inflation of the airbag 27 the leg supporting members 15 and 16 are rotated in a mutually closing direction (a direction where an angle between the two becomes less) by a predetermined amount about the supporting shaft 14.

(b) Massaging Operation 1

Thereafter, in the steps S13 and S14, an operation for executing the massage of the lower thighs by inflation and deflation of the airbags 19 to 22 is executed.

(c) Closing Operation 2 of the Leg Supporting Members 15 and 16

Furthermore, in the step S15, by further inflation of the airbag 27, the leg supporting members 15 and 16 are further rotated in the mutually closing direction (the direction where the angle between the two becomes less) by a predetermined amount about the supporting shaft 14.

(d) Massaging Operation 2

Thereafter, in the steps S16 and S17, an operation executing the massage of the lower thighs by inflation and deflation of the airbags 19 to 22 is executed.

(e) Opening Operation 1 of the Leg Supporting Members 15 and 16

On the other hand, in the step S18 shown in FIG. 14, by deflation of the airbag 27, the leg supporting members 15 and 16 are rotated in a mutually opening direction (a direction where an angle between the two becomes large) by a predetermined amount about the supporting shaft 14.

(f) Massaging Operation 3

Thereafter, in the steps S19 and S20, an operation executing the massage of the lower thighs by inflation and deflation of the airbags 19 to 22 is executed.

(g) Opening Operation 2 of the Leg Supporting Members 15 and 16

Furthermore, in the step S21, by further deflation of the airbag 27, the leg supporting members 15 and 16 are further rotated in the mutually opening direction (the direction where the angle between the two becomes large) by a predetermined amount about the supporting shaft 14.

(f) Massaging Operation 4

Thereafter, in the steps S16 and S17, an operation executing the massage of the lower thighs by inflation and deflation of the airbags 19 to 22 is executed.

In the modified example 6, assuming that a time of executing the closing operation 1 of the leg supporting members 15 and 16 shown in (a) is t1, a time of executing the closing operation 2 of the leg supporting members 15 and 16 shown in (c) is t2, a time of executing the opening operation 1 of the leg supporting members 15 and 16 shown in (e) is t3, and a time of executing the opening operation 2 of the leg supporting members 15 and 16 shown in (g) is t4, the times t1 to t4 are set randomly.

For example, the closing time t1 is two seconds, the closing time t2 is three seconds, the opening time t3 is one second, and the opening time t4 is four seconds. The times t1 to t4 are set randomly by the arithmetic control circuit 36 by use of a random number table or the like.

In this way, by setting the times t1 to t4 randomly, a massage position in a peripheral direction of the left lower thigh by the airbags 19 and 20 and a massage position in a peripheral direction of the right lower thigh by the airbags 19 and 20 can be changed randomly.

Thereby, the lower thighs can be massaged at different positions every repeating the massaging operations shown in (a) to (f) as described above without massaging the same position in the peripheral direction of the right and left lower thighs. Therefore, the massage is prevented from being monotonous and all the positions in the peripheral direction of each of the lower thighs can be massaged.

Meanwhile, the entire closing time T1 (t1+t2) and the entire opening time T2 (t3+t4) are preferably set to be the same with respect to each other.

A massage time of each of the massaging operations 1 to 4 can also be set randomly. In addition, a number and an amount of the inflation and the deflation of the airbags 19 to 22 in the massaging operations 1 to 4 can be set randomly.

As mentioned above, in the massaging apparatus in the mode, the pair of right and left supporting members or leg supporting members 15 and 16 are disposed adjacently and the grooves or lower thigh-location grooves 15a and 16a in the supporting members are disposed in parallel to each other. In addition, the rotational means or airbags 27 and 28 rotate the pair of supporting members or leg supporting members 15 and 16 in such a manner that opened ends of the pair of grooves or lower thigh-location grooves 15a and 16a approach to and separate from each other to open and close the pair of supporting members or leg supporting members 15 and 16. Moreover, the control means or arithmetic control circuit 36 operates and controls the rotational means or airbags 27 and 28 such that the opening and closing times of the pair of supporting members or leg supporting members 15 and 16 are in random.

With the structure, because the opening and closing times of the pair of supporting members or leg supporting members 15 and 16 are set randomly, the massage position in the peripheral direction of the left lower thigh by the massagers or airbags 19 and 20 and the massage position in the peripheral direction of the right lower thigh by the massagers or airbags 19 and 20 can be changed randomly, Thereby, the lower thighs can be massaged at different positions every repeating the opening and closing of the pair of supporting members or leg supporting members 16 and 16 and the massaging operations by the massagers or airbags 19 to 22 without massaging the same position in the peripheral direction of the right and left lower thighs. Therefore, the massage is prevented from being monotonous and all the positions in the peripheral direction of each of the lower thighs can be massaged.

[Mode 2 for Carrying Out the Invention]

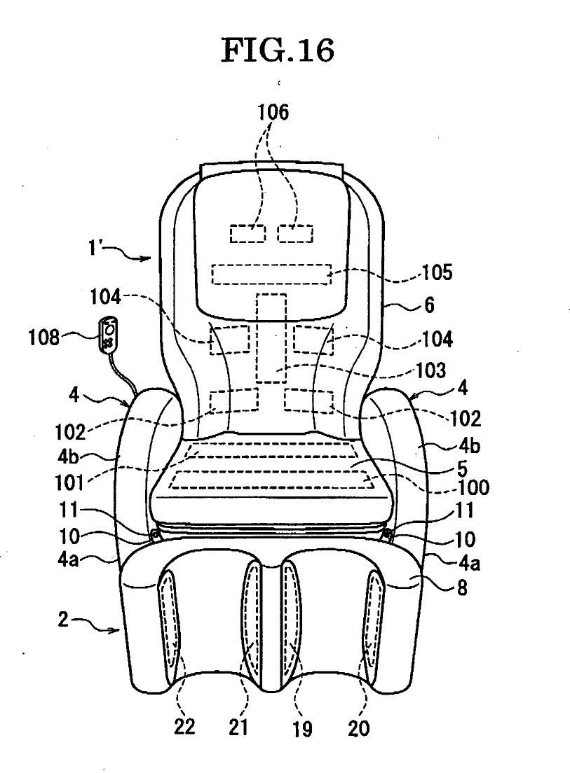

In the embodiment as mentioned above, although the massaging apparatus 2 is applied to the chair 1 in which airbags are not provided in the seat 5 and the backrest 6, the present invention is not necessarily limited to this embodiment. For example, the massaging apparatus 2 for the lower thighs may be applied to an airbag type-chair 1′ (massaging apparatus for upper thighs and an upper body other than the lower thighs) in which airbags are provided on body contacting surfaces of the seat 5 and the backrest 6 as shown in FIG. 16.

Next, the airbag type-massaging chair 1′ including the massaging apparatus 2 for the lower thighs is explained.

In addition, the same reference numbers are attached to members and portions similar to that in the above-mentioned embodiment, the same description is omitted partly.

In FIG. 16, an airbag 100 for upper thighs is provided in a front side of a body contacting surface (upper surface) of the seat 5 and an airbag 101 for the upper thighs is provided in a back side of the body contacting surface (upper surface) on the seat 5.

Rightward and leftward disposed airbags 12 for waist or hip are provided in a lower side of a body contacting surface (front surface) of the backrest 6 and an upwardly and downwardly extending airbag 13 for muscle of a user's back is provided in a central part across a right side and a left side on a lower side of the body contacting surface (front surface) of the backrest 6. In addition, airbags 104 and 104 for the user's back are disposed on the body contacting surface (front surface) of the backrest 6 to be positioned upward and downward and rightward and leftward of the airbag 103 for the muscle of the back.

Furthermore, a rightward and leftward extending airbag 105 for shoulders is provided in an upper part of the body contacting surface (front surface) of the backrest 6 to be positioned above of the airbag 103 for the muscle of the back, and airbags 106 and 106 for the user's neck are provided to be positioned above of the airbag 105 for the shoulders.

Meanwhile, a massage for the shoulders and the neck may be executed by the airbags 106 and 106 for the neck, omitting the airbag 105 for the shoulders. However, in this embodiment, for convenience, the airbag 105 for the shoulders and the airbags for the neck are separately provided.

Such airbags 100 to 106 are connected through a rotary valve 107 (one portion of an air distributing means and the air supply-exhaust means 35) and air hoses 100h to 106h with an air hose 19h, as shown in FIG. 18. In addition, the air hose 19h is connected with an air outlet (not shown) of the air compressor 38.

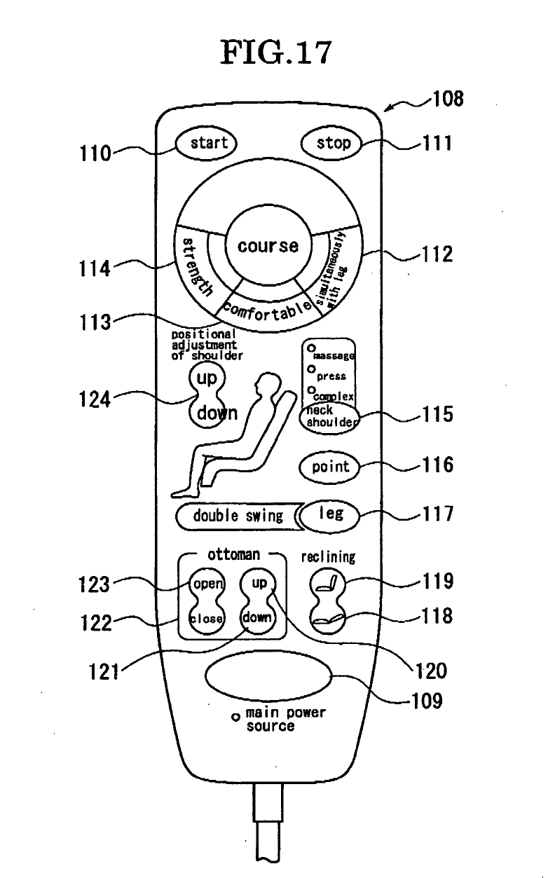

Moreover, a remote control 108 shown in FIGS. 16 and 17 is connected with an arithmetic control circuit 36 shown in FIG. 18. The remote control 108 includes a power source switch 109, a start switch 110, a stop switch 111, a switch 112 for massaging the legs simultaneously, a switch 113 for a comfortable course, and a strong-weak switching switch 114 for switching strong and weak of a massage.

In addition, the remote control 108 includes a switch 115 for massaging the shoulders and the neck, a switch 116 for a point massage, a switch 117 for double-swinging the massaging apparatus 2, a switch 118 for reclining the backrest 6, and a switch 119 for rising the backrest 6 from a reclined state.

Furthermore, the remote control 108 includes a switch 120 for rotating upwardly and adjusting the leg rest 8 of the massaging apparatus 2, a switch 121 for rotating downwardly and adjusting the leg rest 8, a switch 122 for rotating and adjusting the leg supporting members 15 and 16 of the massaging apparatus 2 in a closing direction, a switch 123 for rotating and adjusting the leg supporting members 15 and 16 in an opening direction, and a switch 124 for adjusting a shoulder massaging position upwardly and downwardly.

In addition, the arithmetic control circuit 36 operates, when the switch 117 for the double swing of the massaging apparatus 2 is pressed, the air compressor 38, and operates and controls the air supply-exhaust valve 41 to inflate and deflate the airbags 31 to 34 and to swing the leg rest 8 upwardly and downwardly, and operates and controls the air supply-exhaust valve 40 to inflate and deflate the airbags 27 and 28 and to control the opening and closing of the leg supporting members 15 and 16, and operates and controls the air supply-exhaust valve 39 to inflate and deflate the airbags 19 to 22 and to massage the calves of the lower thighs by the airbags 19 to 22. The massage is executed by the control similar to that in the mode 1 as mentioned above, or as in the modified examples as mentioned above.

Moreover, the arithmetic control circuit 36 operates the air compressor 38 by operation of the switch 120, and operates and controls the air supply-exhaust valve 41 to inflate the airbags 31 to 34, or stops the operation of the air compressor 38 by operation of the switch 121 and operates and controls the air supply-exhaust valve 41 to discharge air in the airbags 31 to 34 and to deflate these airbags. Thereby, the leg rest 8 is swung upwardly and downwardly so that an upward and downward position of the leg rest is adjusted.

Furthermore, the arithmetic control circuit 36 operates the air compressor 38 by operation of the switch 122, and operates and controls the air supply-exhaust valve 40 to inflate the airbags 27 and 28, or stops the operation of the air compressor 38 by operation of the switch 123 and operates and controls the air supply-exhaust valve 40 to discharge air in the airbags 27 and 28 and to deflate these airbags. Thereby, the leg supporting members 15 and 16 are adjustably opened and closed so that an angle between the leg supporting members 15 and 16 is adjusted.

In addition, the arithmetic control circuit 36 operates, when the start switch 119 is pressed in an upward and downward adjusting position of the leg rest 8 and an adjusting position of tho opening and closing angle of the leg supporting members 15 and 16, the air compressor 38 in the adjusting positions, and operates and controls the air supply-exhaust valve 39 to inflate and deflate the airbags 19 to 22 and massage the calves of the lower thighs by the airbags 19 to 22.

[Operation]

Next, an operation of the massage course for massaging the legs simultaneously by the arithmetic control circuit 36 of the massaging chair 1′ (massaging apparatus) is explained.

In the above-mentioned structure, the arithmetic control circuit 36 operates and controls the air supply-exhaust valve 39 as described above, to inflate and deflate the airbags 19 to 22 and massage the calves of the lower thighs by the airbags 19 to 22.

In addition, the arithmetic control circuit 36 operates and controls the rotary valve 107 to inflate and deflate intermittently the airbags 100 to 106 in sequence. By inflation and deflation of the airbag 100, the upper thighs are massaged, the hip by inflation and deflation of the airbag 101, the waist by inflation and deflation of the airbag 102, the muscle of the back by inflation and deflation of the airbag 103, the back by inflation and deflation of the airbag 104, the shoulders by inflation and deflation of the airbag 105, and the neck by inflation and deflation of the airbag 106.

Moreover, the arithmetic control circuit 36 is configured to execute the leg massage simultaneously when the upper thighs, hip, waist, muscle of back, back, shoulders, neck and so on are massaged intermittently in this order. Also, the arithmetic control circuit 36 is configured to execute the opening and closing control of the leg supporting members 15 and 16 of the massaging apparatus 2 as follows, during executing intermittently the massage of the upper thighs, hip, waist, muscle of back, back, shoulders, neck and so on, in this order.

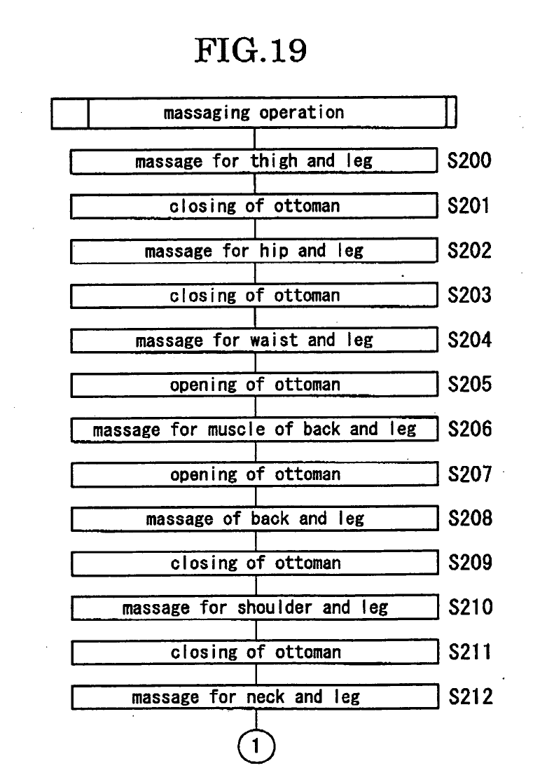

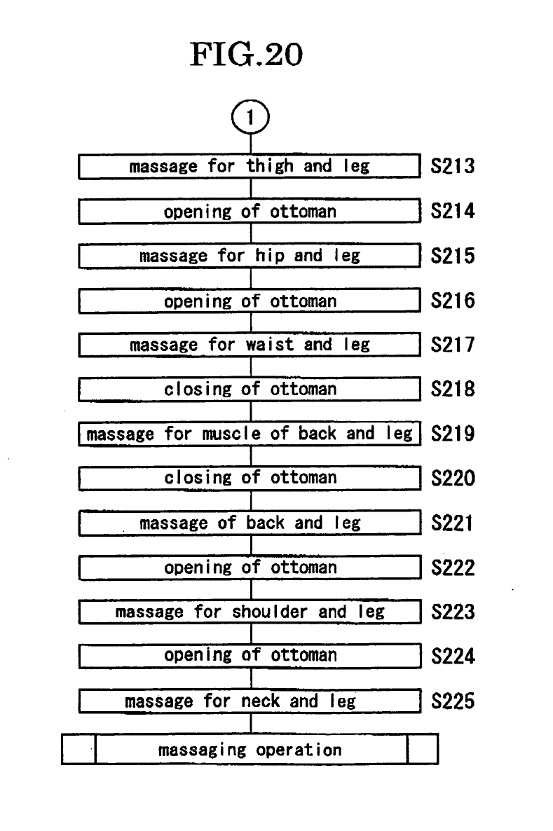

That is to say, when the power source switch 109 of the remote control 108 is turned on, the switch 112 for massaging the legs simultaneously is turned on, and the start switch 110 is turned on, the massage control operation in the flow chart shown in FIG. 19 is started.

(A) Massage Control I

The arithmetic control circuit 36 executes the inflation and deflation control of each of the above-mentioned airbags, and is configured to massage the upper thighs and the calves of the lower thighs simultaneously in step S200, thereafter close the leg supporting members 15 and 16 of the massaging apparatus 2 by a predetermined amount in step S201, then massage the hip and the calves of the lower thighs simultaneously in step S202, thereafter close the leg supporting members 15 and 16 of the massaging apparatus 2 by a further predetermined amount in step S203.

Next, the arithmetic control circuit 36 executes the inflation and deflation control of each of the above-mentioned airbags, and is configured to massage the waist and the calves of the lower thighs simultaneously in step S204, thereafter open the leg supporting members 15 and 16 of the massaging apparatus 2 by a predetermined amount in step S206, then massage the muscle of the back and the calves of the lower thighs simultaneously in step S206, thereafter open the leg supporting members 15 and 16 of the massaging apparatus 2 by a further predetermined amount in step S207.

Furthermore, the arithmetic control circuit 36 executes the inflation and deflation control of each of the above-mentioned airbags, and is configured to massage the back and the calves of the lower thighs simultaneously in step S208, thereafter close the leg supporting members 15 and 16 of the massaging apparatus 2 by a predetermined amount in step S209, then massage the shoulders and the calves of the lower thighs simultaneously in step S210, thereafter close the leg supporting members 15 and 16 of the massaging apparatus 2 by a further predetermined amount in step S211, and massage the neck and the calves of the lower thighs simultaneously in step S212.

(B) Massage Control II

After the massaging control in steps S200 to S222 is executed, a massage control in steps S22,3 to S235 is executed.

That is to say, the arithmetic control circuit 36 executes the inflation and deflation control of each of the above-mentioned airbags, and is configured to massage the upper thighs and the calves of the lower thighs simultaneously in step S213, thereafter open the leg supporting members 15 and 16 of the massaging apparatus 2 by a predetermined amount in step S214, then massage the hip and the calves of the lower thighs simultaneously in step S215, thereafter open the leg supporting members 15 and 16 of the massaging apparatus 2 by a further predetermined amount in step S216.

Next, the arithmetic control circuit 36 executes the inflation and deflation control of each of the above-mentioned airbags, and is configured to massage the waist and the calves of the lower thighs simultaneously in step S217, thereafter close the leg supporting members 15 and 16 of the massaging apparatus 2 by a predetermined amount in step S218, then massage the muscle of the back and the calves of the lower thighs simultaneously in step S219, thereafter close the leg supporting members 15 and 16 of the massaging apparatus 2 by a further predetermined amount in step S220.

Furthermore, the arithmetic control circuit 36 executes the inflation and deflation control of each of the above-mentioned airbags, and is configured to massage the back and the calves of the lower thighs simultaneously in step S221, thereafter open the leg supporting members 15 and 16 of the massaging apparatus 2 by a predetermined amount in step S222, then massage the shoulders and the calves of the lower thighs simultaneously in step S223, thereafter open the leg supporting members 15 and 16 of the massaging apparatus 2 by a further predetermined amount in step S224, and massage the neck and the calves of the lower thighs simultaneously in step S225.

(C) Repeated Massaging Control

The arithmetic control circuit 36 executes repeatedly the massage control I and the massage control II of the simultaneous massage course as mentioned above when the switch 112 for massaging the legs simultaneously and the start switch 110 are turned on. At this time, when the stop switch 111 is pressed, the massage control is stopped.

Meanwhile, the massage controls I and II in the simultaneous massage course may be repeatedly executed predetermined times and completed.

In the massage controls I and II, because the opening and closing controls for the leg supporting members 15 and 16 in massaging portions on the upper thighs, hip, waist, muscle of back, back, shoulders, neck and 80 on are opposite with respect to each other, the massage is not monotonous and advantageous effects of the massage are increased.

In the massage controls I and II in the simultaneous massage course, the control of the massaging apparatus 2 shown in the mode 1 or a combination of the controls of the massaging apparatuses shown in the modified examples as mentioned above may be used.

As mentioned above, in the massaging apparatuses in the modes for carrying out the present invention, the treated part-mounting table is the leg rest 8 used by combination with the chair (massage chair 1′), massagers or airbags 19 to 22 for massaging the calves of the lower thighs are disposed in the located grooves or lower thigh-location grooves 15a and 15b of the supporting members 15 and 16 provided on the leg rest 8, and the massagers or airbags 100 to 106 for the chair to execute the massage of parts upper than the user's calves are provided in the body contacting surfaces of the chair. In addition, the control means or arithmetic control circuit 36 of the massaging apparatus operates the massager operating means or air supply-exhaust means 35 to massage the calves of the lower thighs by the massagers for the calves or airbags 19 to 22 and simultaneously to execute the massage of the upper parts than the calves by the airbags 100 to 106.

With the structure, because the user's lower thighs and one portion of the parts-upper than the lower thighs can be massaged simultaneously, massage effects are increased. Moreover, by combining the opening and closing operation of the leg supporting members 15 and 16 during repeating the simultaneous massage intermittently, it is possible to open and close the leg supporting members 15 and 16 automatically after the simultaneous massage and change automatically the massage points of the lower thighs peripherally of the lower thighs, whereby increasing massage effects.

In the massaging apparatus in each of the modes, the switch 112 to simultaneously operate the massagers or airbags 19 to 22 for the calves and the massagers or airbags 100 to 106 for the chair is provided. With the structure, the user's lower thighs and one portion of the upper parts than the lower thighs can be massaged simultaneously by operation of the switch 112.

If the switch 112 is not operated, only the massage by the massaging apparatus 2 is executed in various states (mode 1 and modified examples), or the operation of the massaging apparatus 2 is stopped and massages other than the lower thighs can be execute. In addition, in case of executing the massage by the massaging apparatus 2, after the upward and downward rotation of the leg rest 8 and the opening and closing of the leg supporting members 15 and 16 are adjusted, as mentioned in the mode 2, at this adjusted position, only the massage of the lower thighs by the airbags 19 to 22 can be executed.

### EFFECT OF THE INVENTION

According to the present invention, because the users treated part while rotating the supporting members is massaged, the massage positions of the treated part of the user can be changed along the peripheral direction of the treated part.

1. A massaging apparatus comprising:
a treated part-mounting table including a supporting member which is provided with a located groove in which a treated part of a user is disposed and rotatably provided peripherally of the located groove;
rotational means for rotating the supporting member peripherally of the located groove;
a massager provided in the located groove;
massager operating means for operating the massager and massaging the treated part by the massager; and
control means for operating and controlling the rotational means and the massager operating means,
and wherein the control means is configured to massage the treated part by the massager by operating the massager operating means while operating the supporting member peripherally of the located groove by operating rotational means.

2. The massaging apparatus according to claim 1,
wherein:
the massager comprises an airbag attached to at least one of opposing walls of the located groove, the massager operating means comprises an air supply-exhaust means for supplying air to and exhausting air from the airbag to inflate and deflate the airbag, and
the control means controls the rotational means to rotate the rotational means when the airbag is in an air exhausted state and stop the rotation of the rotational means when the airbag is in an air supplied state, and to massage intermittently the treated part by the airbag while rotating intermittently the supporting member peripherally of the located groove.

3. The massaging apparatus according to claim 1,
wherein:
the massager comprises an airbag attached to at least one of opposing walls of the located groove,
the massager operating means comprises an air supply-exhaust means for supplying air to and exhausting air from the airbag to inflate and deflate the airbag, and
the control means controls the rotational means to rotate the rotational means when the airbag is in an air exhausted state and to massage the treated part by the airbag.

4. The massaging apparatus according to claim 1,
wherein the treated part-mounting table comprises a leg rest which is rotatably attached upwardly and downwardly to a lower portion of a front side of a seat of a chair,
further comprising rest drive means for driving upwardly and downwardly the leg rest, and
wherein the control means operates the rest drive means to execute the massage while driving upwardly and downwardly the leg rest.

5. The massaging apparatus according to claim 4,
wherein the control means drives the leg rest by a predetermined amount in one of upward and downward directions and executes the massage, thereafter drives the leg rest by an amount lesser than the predetermined amount in the opposite direction to the one of upward and downward directions, and repeats the operation of executing the massage in a predetermined range.

6. The massaging apparatus according to claim 1,
wherein the control means drives the supporting member by a predetermined amount in one of a peripheral direction and executes the massage, thereafter drives the supporting member by an amount lesser than the predetermined amount in the opposite direction to the one direction, and repeats the operation of executing the massage in a predetermined range.

7. The massaging apparatus according to claim 1,
including a pair of right and left supporting members which are adjacently disposed,
located grooves in the pair of supporting members are provided in parallel,
the rotational means rotates the pair of supporting members so that opening ends of the located grooves approach to and separate from each other to open and close the pair of supporting members, and
the control means operates and controls the rotational means so that an opening and closing time of the pair of supporting members is random.

8. The massaging apparatus according to claim 1,
wherein the treated part-mounting table comprises a leg rest used by combination with a chair,
further comprising a massager for a calf provided in the located groove of the supporting member and configured to massage a calf of the lower thigh as the treated part and a massager for the chair provided in a body contacting surface of the chair and configured to massage an upper part than the calf of the user, and
wherein the control means operates the massager operating means to massage the calf by the massager for the calf and simultaneously massage the upper part than the calf by the massager for the chair.

9. The massaging apparatus according to claim 8,
further comprising a switch to operate the massager for the calves and the massager for the chair simultaneously.

10. The massaging apparatus according to claim 2,
wherein the treated part-mounting table comprises a leg rest which is rotatably attached upwardly and downwardly to a lower portion of a front side of a seat of a chair,
further comprising rest drive means for driving upwardly and downwardly the leg rest, and
wherein the control means operates the rest drive means to execute the massage while driving upwardly and downwardly the leg rest.

11. The massaging apparatus according to claim 10,
wherein the control means drives the leg rest by a predetermined amount in one of upward and downward directions and executes the massage, thereafter drives the leg rest by an amount lesser than the predetermined amount in the opposite direction to the one of upward and downward directions, and repeats the operation of executing the massage in a predetermined range.
